(19) United States
(12) Patent Application Publication
(10) Pub. No.: US 2025/0148791 A1
(43) Pub. Date: May 8, 2025

(54) IMAGE PROCESSING METHOD, APPARATUS, ELECTRONIC DEVICE AND STORAGE MEDIUM

(71) Applicant: SAMSUNG ELECTRONICS CO., LTD., Suwon-si (KR)

(72) Inventors: Shizhuo Liu, Beijing (CN); Xiaobing Wang, Beijing (CN); Zhezhu Jin, Beijing (CN)

(73) Assignee: SAMSUNG ELECTRONICS CO., LTD., Suwon-si (KR)

(21) Appl. No.: 19/005,493

(22) Filed: Dec. 30, 2024

Related U.S. Application Data
(63) Continuation of application No. PCT/KR2023/008963, filed on Jun. 27, 2023.

(30) Foreign Application Priority Data
Jun. 28, 2022 (CN) 202210753534.6

(51) Int. Cl. G06V 20/40; G06V 10/26; G06V 10/762; G06V 10/77; G06V 10/82

(52) U.S. Cl. CPC G06V 20/49; G06V 10/26; G06V 10/762; G06V 10/7715; G06V 10/82; G06V 20/46

(57) ABSTRACT

An image processing method includes: obtaining first image patches corresponding to an image to be processed; dividing the first image patches into at least two groups via a window self-attention network; determining global attention information among the first image patches in the at least two groups of the first image patches, respectively; obtaining second image patches comprising local attention information; and determining a recognition result of the image to be processed based on the second image patches.

### CROSS-REFERENCE TO RELATED APPLICATION(S)

This application is a continuation of International Application No. PCT/KR2023/008963, filed on Jun. 27, 2023, in the Korean Intellectual Property Receiving Office, which is based on and claims priority to Chinese Patent Application No. 202210753534.6, filed on Jun. 28, 2022, in the China National Intellectual Property Administration, the disclosures of which are incorporated by reference herein in their entireties.

### BACKGROUND

### 1. Field

The present disclosure relates to a technical field of computer vision, and in particular, to an image processing method, apparatus, electronic device and storage medium.

### 2. Description of Related Art

Highlight Recognition, also known as highlight video recognition, refers to a recognition of a location where a highlight video occurs in a long video, so it may also be referred to as highlight locating or highlight video locating. Since the highlight video part is more likely to attract the attention of the audience, an efficiency of video dissemination may be improved by quick viewing of a highlight video part. And it would waste too much time to find the highlight moment of the video artificially. Therefore, the application of highlight recognition technology has gradually become popular. However, the current highlight recognition method still performs poorly in terms of a recognition effect such as recognition of tiny actions.

### SUMMARY

Provided is a an image processing method, apparatus, electronic device, and storage medium be capable of solving a problem of how to improve a recognition effect for tiny actions in highlight recognition.

Additional aspects will be set forth in part in the description which follows and, in part, will be apparent from the description, or may be learned by practice of the presented embodiments.

According to an aspect of the disclosure, an image processing method may include: obtaining first image patches corresponding to an image to be processed; dividing the first image patches into at least two groups via a window self-attention network; determining global attention information among the first image patches in the at least two groups of the first image patches, respectively; obtaining second image patches comprising local attention information; and determining a recognition result of the image to be processed based on the second image patches.

The determining the recognition result of the image to be processed based on the second image patches may include: determining, by a global token generator, at least one global token corresponding to at least part of the image to be processed, based on the first image patches; and determining the recognition result of the image to be processed, based on the at least one global token and the second image patches.

The global token generator may include a kernel generator, where the determining, by the global token generator, the at least one global token corresponding to the at least part of the image to be processed based on the first image patches, includes: generating at least one kernel for the image to be processed, by the kernel generator; and determining the at least one global token respectively corresponding to the at least one kernel, based on the at least one kernel and the first image patches.

The determining the recognition result of the image to be processed based on the at least one global token and the second image patches, may include: determining, via a cross-attention network, attention information among the at least one global token and the second image patches; obtaining third image patches comprising the global attention information and the local attention information; and determining the recognition result of the image to be processed based on the third image patches.

At least one of the window self-attention network, the global token generator or the cross-attention network may include a first neural network, where the determining the recognition result of the image to be processed based on the first image patches include: obtaining fourth image patches comprising the global attention information and the local attention information based on the first image patches, via at least one first neural network; and determining the recognition result of the image to be processed, based on the fourth image patches, where, the obtaining the fourth image patches comprising the global attention information and the local attention information based on the first image patches, via the at least one first neural network, further includes: performing down sampling for the first image patches, and where the at least one down sampling respectively includes: down sampling output image patches of a previous first neural network to obtain down sampled results; and inputting the down sampled results into a first neural network next to the previous first neural network.

For each of the output image patches of the first neural network, the down sampling the output image patches may include: grouping feature points of each of the output image patches into grouped feature maps; and concatenating the grouped feature maps in a channel dimension to obtain connected feature maps.

The determining the recognition result of the image to be processed based on the third image patches may include: determining fifth image patches comprising the global attention information, the local attention information and temporal information based on the third image patches, via a second neural network; and determining the recognition result of the image to be processed, based on the fifth image patches.

The determining the fifth image patches including the global attention information, the local attention information and the temporal information based on the third image patches, via the second neural network, may include: obtaining, from a predetermined short memory pool, sixth image patches corresponding to at least one frame of a processed image prior to the image to be processed; determining temporal third image patches comprising the global attention information, the local attention information and the temporal information, based on the third image patches and the sixth image patches; down sampling the third image patches to obtain seventh image patches; obtaining, from a predetermined long memory pool, eighth image patches corresponding to the at least one frame of the processed image prior to the image to be processed; determining temporal seventh image patches comprising temporal information, based on the seventh image patches and the eighth image patches; and obtaining the fifth image patches comprising global attention information, local attention information and temporal information, based on the temporal third image patches and the temporal seventh image patches.

The method may further include at least one of: updating the short memory pool, based on the temporal third image patches; or updating the long memory pool, based on the temporal seventh image patches.

The image to be processed may include a plurality of frames, where the determining the recognition result of the image to be processed includes determining a recognition result of the plurality frames, respectively, and where the method further includes: recognizing one or more highlight portions among the plurality of frames.

The recognizing the one or more highlights among the plurality of frames may include: dividing the image to be processed into a plurality of snippets of a fixed length; determining a highlight recognition score for the plurality of snippets, respectively; classifying the plurality of snippets into highlight portions or non-highlight portions based on the highlight recognition score.

The recognizing the one or more highlights among the plurality of frames may further include: integrating adjacent snippets classified as a highlight portion, based on the adjacent snippets corresponding to a same type of highlight; and determining a start time and an end time of the integrated adjacent snippets.

The at least one global token may correspond to one or more features to be extracted in the image to be processed, where the generating the at least one kernel for the image to be processed, by the kernel generator, includes: adapting a size of the at least one kernel to correspond to the one or more features to be extracted.

A resolution of the second image patches may be lower than a resolution of the first image patches.

According to an aspect of the disclosure, an image processing apparatus may include: at least one processor; and at least one memory storing instructions executable by the at least one processor, where, by executing the instructions, the at least one processor is configured to control: a first obtaining module to obtain first image patches corresponding to an image to be processed; a first processing module to: divide the first image patches into at least two groups via a window self-attention network, determine global attention information among first image patches in the at least two groups of the first image patches, respectively, and obtain second image patches comprising local attention information; and a first recognition module to determine a recognition result of the image to be processed, based on the second image patches.

The at least one processor may be further configured to control: the first processing module to: determine, by a global token generator, at least one global token corresponding to at least part of the image to be processed, based on the first image patches; and the first recognition module to: determine the recognition result of the image to be processed, based on the at least one global token and the second image patches.

The global token generator may include a kernel generator, where the at least one processor is further configured to control: the first processing module to: generate at least one kernel for the image to be processed, by the kernel generator; and the first recognition module to: determine the at least one global token respectively corresponding to the at least one kernel, based on the at least one kernel and the first image patches.

The at least one processor may be further configured to control: the first processing module to: determine, via a cross-attention network, attention information among the at least one global token and the second image patches, and obtain third image patches including global attention information and local attention information; and the first recognition module to: determine the recognition result of the image to be processed based on the third image patches.

At least one of the window self-attention network, the global token generator and the cross-attention network may include a first neural network, wherein the at least one processor is further configured to: for determining the recognition result of the image to be processed based on the first image patches, control the first processing module to: obtain fourth image patches comprising the global attention information and local attention information based on the first image patches, via at least one first neural network; for determining the recognition result of the image to be processed based on the first image patches, control the first recognition module to: determine the recognition result of the image to be processed, based on the fourth image patches; for obtaining the fourth image patches comprising the global attention information and the local attention information based on the first image patches via the at least one first neural network, control the first processing module to: perform at least one down sampling for the first image patches; and for performing the at least one down sampling, control the first processing module to: down sample output image patches of a previous first neural network to obtain down sampled results, and input the down sampled results into a first neural network next to the previous first neural network.

A non-transitory computer readable storage medium having a computer program stored therein, wherein when the computer program is executed by the processor, the computer program performs an image processing method including: obtaining first image patches corresponding to an image to be processed; dividing the first image patches into at least two groups via a window self-attention network; determining global attention information among the first image patches in the at least two groups of the first image patches, respectively; obtaining second image patches comprising local attention information; and determining a recognition result of the image to be processed based on the second image patches.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is an example diagram of a highlight moment in a video according to an embodiment of the present disclosure;

FIG. 2 is a flowchart of an image processing method according to an embodiment of the present disclosure;

FIG. 3A is a schematic diagram of calculating local attention information according to an embodiment of the present disclosure;

FIG. 3B is a schematic diagram of extracting global tokens according to an embodiment of the present disclosure;

FIG. 3C is a schematic diagram of calculating global attention information according to an embodiment of the present disclosure;

FIG. 4 is a schematic diagram of an execution process of a global token generator according to an embodiment of the present disclosure;

FIG. 5 is a schematic diagram of a first neural network according to an embodiment of the present disclosure;

FIG. 6 is a schematic diagram of an execution process of a first neural network according to an embodiment of the present disclosure;

FIG. 7 is a schematic diagram of an execution process of a cross granularity transformer network according to an embodiment of the present disclosure;

FIG. 8 is a schematic diagram of image patch merging according to an embodiment of the present disclosure;

FIG. 9 is a schematic diagram of a second neural network according to an embodiment of the present disclosure;

FIG. 10 is a first schematic diagram of an execution process of a second neural network according to an embodiment of the present disclosure;

FIG. 11 is a second schematic diagram of the execution process of the second neural network according to an embodiment of the present disclosure;

FIG. 12 is a first schematic diagram of a highlight recognition process according to an embodiment of the present disclosure;

FIG. 13 is a second schematic diagram of the highlight recognition process according to an embodiment of the present disclosure;

FIG. 14A is a first schematic diagram of image pre-processing according to an embodiment of the present disclosure;

FIG. 14B is a second schematic diagram of image pre-processing according to an embodiment of the present disclosure;

FIG. 15 is a schematic diagram of an execution process for obtaining highlight snippets according to an embodiment of the present disclosure;

FIG. 16A is a schematic diagram of a method for extracting temporal information according to an embodiment of the present disclosure;

FIG. 16B is a schematic diagram of a temporal transformer according to an embodiment of the present disclosure;

FIG. 17A is a schematic diagram of a flow of another image processing method according to an embodiment of the present disclosure;

FIG. 17B is a schematic diagram of a flow of yet another image processing method according to an embodiment of the present disclosure;

FIG. 18 is a schematic diagram of a structure of an image processing apparatus according to an embodiment of the present disclosure;

FIG. 19 is a schematic diagram of a structure of another image processing apparatus according to an embodiment of the present disclosure;

FIG. 20 is a schematic diagram of a structure of yet another image processing apparatus according to an embodiment of the present disclosure; and

FIG. 21 is a schematic diagram of a structure of an electronic device according to an embodiment of the present disclosure.

### DETAILED DESCRIPTION

Embodiments of the present disclosure are described below with reference to the accompanying drawings in the present disclosure. It should be understood that the embodiments set forth below with reference to the accompanying drawings are exemplary descriptions for the purpose of explaining the technical solutions of the embodiments of the present disclosure, and do not constitute a limitation to the technical solutions of the embodiments of the present disclosure.

It will be understood by those skilled in the art that the singular forms “a”, “an” and “the” as used herein may also include plural forms, unless otherwise stated. It should be further understood that the terms “includes,” “comprises,” “has,” “having,” “including,” “comprising,” and the like, when used in the embodiments of the present disclosure, indicate that the corresponding features may presented as features performed, information, data, steps, operations, elements and/or components, but do not exclude other features to be performed, other information, other data, other steps, other operations, other elements, other components and/or a combination thereof that are supported in the technical art. It should be understood that an element being “connected” or “coupled” to another element may be directly connected or coupled to the other element, or it may refer to the element and the other element being connected via an intermediate element. In addition, the “connecting” or “coupling” used herein may comprise a wireless connection or wireless coupling. The term “and/or” as used herein indicates at least one of the items defined by the terms, e.g., “A and/or B” may be performed as “A”, or as “B”, or “A and B”. The term “or” includes any and all combinations of one or more of a plurality of associated listed items.

In order to make the object, technical solutions and advantages of the present disclosure clearer, embodiments of the present disclosure will be further described in conjunction with the accompanying drawings as below in detail.

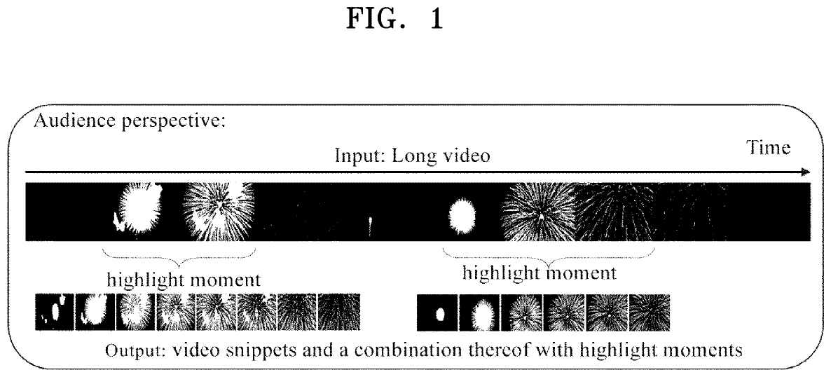

An object of highlight recognition is to obtain a highlight snippet from a series of images such as specific action types, scenes of a long video, including but not limited to a human, a scenery, an event, etc. For example, as shown in FIG. 1, the clips of firework explosion are highlight moments in the firework video.

In some related techniques, highlight recognition may be achieved by a Convolutional Neural Network (CNN), however, the following difficulties generally exist in related techniques:

(1) It cannot recognize tiny actions (e.g., small details such as wearing a ring, blowing a candle, etc.).

(2) Multiple frames of images are required as input, and processing multiple frames leads to a serious decrease in an operation speed, which hinders the possibility of online operation and makes it more difficult to deploy on terminal devices.

(3) The model size is too large to be deployed on edge devices.

(4) If image resolution is simply increased for processing in order to improve the recognition effect, the computing amount will grow in a quadratic rate, making the computing amount too large.

In general, highlight recognition methods usually used in servers may be difficult to deploy on a mobile device due to the limitation of computing capability of mobile devices. Regarding to the model used in the servers, on the one hand, the volume of the model is large, and when the model is loaded it may require a high content capacity, which may affect an overall performance of mobile devices when the model is used; on the other hand, the computing amount of the model is high, and the computing capability of the mobile device is insufficient to support the computing requirements of the model, and thus it may also lead to serious local heating. The highlight recognition method currently used in a mobile terminal has a poor recognition effect for tiny actions. Related highlight recognition methods use multiple frames of images as input; and if multiple frames of images are processed at the same time, an operation time for running the model per run may be quite long, and thus online processing may not be realized.

Regarding the above technical problems, the present disclosure provides a deep learning-based highlight video recognition method, which may achieve a significant improvement in the recognition for tiny actions with lower computing amounts by using a cross granularity transformer. In addition, the method may use one single frame of an image as an input. Therefore, in comparison with using multiple frames as the input, the method may obtain faster processing speed. The network model according to some embodiments may have advantages of a small model, a low number of parameters, and a low computing amount. Therefore, the network model according to some embodiments may better perform the highlight video recognition task and may be applied to mobile devices.

The technical solutions of an embodiment and the technical effects produced by the technical solution of the present disclosure are described below by describing several exemplary embodiments. It should be noted that the following embodiments may be referred to, learned from or combined with each other; and the description of the same terms, similar features and similar implementation steps, etc. in different embodiments will not be repeated.

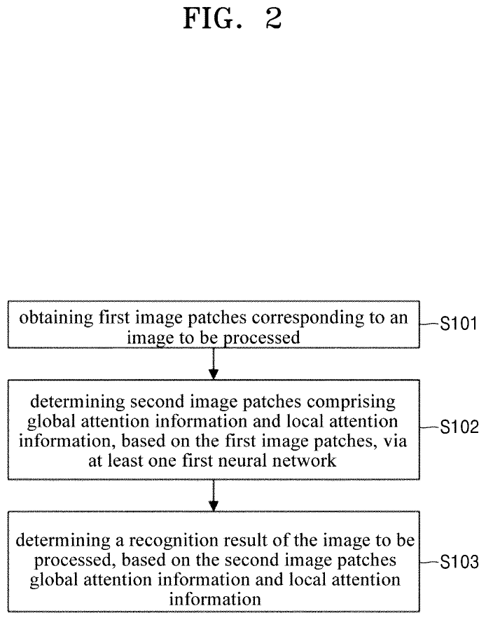

An image processing method is provided in an embodiment of the present disclosure. As shown in FIG. 2, the method may include:

Step S101: obtaining first image patches corresponding to an image to be processed.

In an embodiment of the present disclosure, it may be possible to achieve processing of continuous frames of a video. The image to be processed may refer to one or more frames of the continuous frames of the video. That is, the continuous frames of the video may be sequentially processed as the image to be processed according to an embodiment of the present disclosure. Optionally, the image to be processed may refer to one frame of an image. That is, an input for each running process is one frame of image, and some embodiments may be capable of using one single frame as the input for highlight recognition to achieve a faster processing speed.

The first image patches may be obtained by encoding the image to be processed into a predetermined number of first image patches. In an embodiment, the first image patches may be output results of other networks. When those skilled in the art may combine the present solution with other networks according to the actual situation, a combined technical solution shall also be included in the protection scope of the present disclosure. The following is an example in which the image to be processed is encoded into the first image patches.

In an embodiment an image patch, also called a patch, refers to one or more areas in the image to be processed obtained by encoding the image to be processed. In some embodiments, the image patch may be a basic unit for image processing. As an example, if a frame of an original image with a size of 224*224 is input, the frame of the image may be encoded into 14*14 image patches, and each one of the 14*14 image patches may correspond to 16*16 pixels of the original image. In an embodiment, a frame of image may be encoded into a higher resolution result, by using more image patches, and thus more spatial information may be retained. For example, if a frame of an original image has a size of 224*224 is taken as an example, the frame of the image may be encoded into 56*56 image patches so as to better recognize tiny actions.

In an embodiment, the image to be processed may be encoded into a predetermined number of image patches by using image patch embedding (or referred to as patch embedding). The image patch embedding may be performed by an image patch embedding module. The image patch embedding module may include various structures such as, for example, a 2D convolution operation layer. As an example, if a frame of an original image has a size of 224*224, and is encoded into 56*56 image patches, and the down sampling of the encoding has a multiple of 4, the size of the convolution kernel of the 2D convolution layer may be configured to 4×4, the step size thereof may be configured to 4, the number of input channels may be configured to 3 (Red, Green, Blue), and the number of output channels may be configured to C, but the present disclosure is not limited thereto.

It should be understood that the above several image sizes, numbers of image patches, encoding methods, etc. are only examples. In actual application, those skilled in the art may configure the predetermined number of image patches to be encoded, the encoding methods, etc. according to the actual situation, which is not limited to the present disclosure.

Step S102: dividing the first image patches into at least two groups via a window self-attention network; and determining attention information among first image patches in each group of the first image patches, respectively for each group of the first image patches; and obtaining second image patches comprising local attention information.

For example, Step 102 may include extracting the local attention information among first image patches in each group of the first image patches, respectively for each group of first image patches; and determining the second image patches, based on the first image patches and the extracted local attention information.

In an embodiment, the local attention information may focus on attracting attention to feature information among different image patches. For example, images patches may be associated with each other to determine contents in the image patches after an attention of another image patch has been attracted to the one image patch, but is not limited thereto. Further, the local attention information may be understood as spatial information.

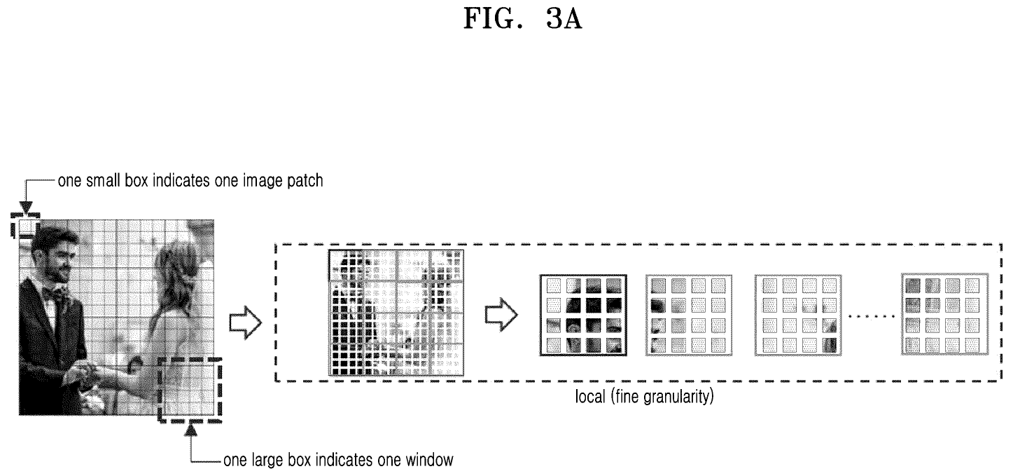

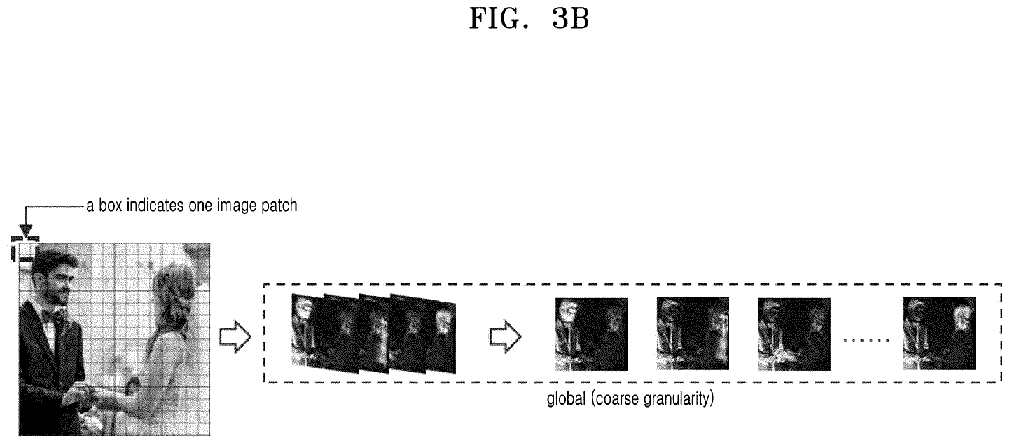

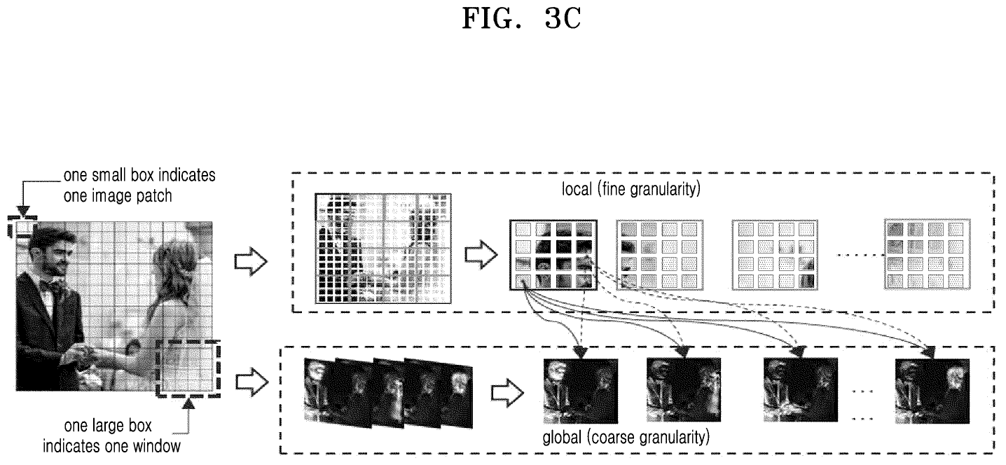

In an embodiment, as shown in FIG. 3a, the window self-attention network may divide the first image patches (one image patch may be referred to the small box in FIG. 3a) into different windows (one window may be referred to the large box in FIG. 3a), and the local attention information may be determined among the image patches in each window.

In an embodiment, the size of the window (i.e., the side length of each window or the number of image patches in each window) may be configured according to the actual situation. As an example, in FIG. 3a, the number of image patches in each window may be configured to 4×4, or may be another value in the actual application, which is not limited to the present disclosure.

It should be noted that the content of the image to be processed shown in FIG. 3a is for illustration only, and the present disclosure may not be concerned with the specific image content. That is, the image content may not limit the present disclosure. The image or image patches to be processed in each figure in the accompanying drawings below is/are the same, and redundant descriptions will not be repeated.

In an embodiment, the output second image patches may have the same size as the first image patches. In an embodiment, the resolution of the output second image patch may be different than the resolution of the first image patches. For example, the resolutions of the first image patches may be adjusted, and processed by the window self-attention network, and the window self-attention network may process them in the same manner.

Step S103: determining a recognition result of the image to be processed, based on the second image patches.

In an embodiment, for a continuous frame image of a given video, an objective of the recognition result is to obtain the location where the highlight video occurs, that is, to obtain the highlight recognition result. In an embodiment, the highlight recognition result of the image to be processed may represent whether the image to be processed is a part of the highlight video. In this case, after the highlight recognition result of each frame of image is obtained, the location of the highlight video may be obtained. In an embodiment, the highlight recognition result of the image to be processed may represent a probability value that the image to be processed belongs to a certain type of highlight video. In this case, after the highlight recognition result of each frame of the image is obtained, the start time point and the end time point of the highlight video may be further obtained, based on the type of each frame of image, for example, by using a post-processing method such as pyramid sliding window. The representation manner of the highlight recognition result may be configured by those skilled in the art according to the requirements, and it is not limited to the present disclosure.

The image processing method provided in an embodiment may be capable of achieving a significant improvement in the recognition effect for tiny actions by obtaining spatial features with local attention information, and thus, may improve the accuracy of recognition results.

In an embodiment Step S103 may include:
Step S1031: determining at least one global token corresponding to at least part of the image to be processed, based on the first image patches, by a global token generator;
Step S1032: determining the recognition result of the image to be processed, based on the at least one global token and the second image patches.

In an embodiment, as shown in FIG. 3b, the global token generator may extract a group of global tokens from the first image patches (an image patch may be referred to a box in FIG. 3b). Each global token is a representation of an image patch for information, and is capable of representing global (coarse granularity) semantic (attention) information of the entire image to be processed. The global attention information may focus on feature information of the entire image to be processed, such as, but not limited to, what items are present at what locations in the figure, etc. Further, the global attention information may also be understood as spatial information.

For example, in a global token as shown in FIG. 3b, it may be expressed that a man's head is in the upper left corner. Further, different global tokens may focus on different spatial information. For example, one global token is more concerned with the head information of the man, another global token is more concerned with the veil of the woman, etc., but not limited thereto.

Similarly, in an embodiment, the output second image patches may have the same size as the first image patches. In an embodiment, the resolutions of the output second image patches may be different from the resolution of the first image patches. For example, the resolutions of the first image patch may be adjusted, and processed by the global token generator, and may be processed in the same manner by the global token generator.

In an embodiment, the number of global tokens extracted by the global token generator may be configured according to the actual situation. As an example, the number of global tokens extracted by the global token generator may be configured to 8 or another value in order to balance the relationship between the computing amount and accuracy, and the embodiment of the present disclosure will not be limited thereto.

In an embodiment, the global token generator may include a kernel generator, and step S1031 may include: generating at least one kernel for the image to be processed, by the kernel generator; determining the at least one global token respectively corresponding to the at least one kernel, based on the at least one kernel and the first image patches.

In related computing methods, the features are extracted by a kernel with fixed weights. In an embodiment, the kernels used may not have fixed-weights. That is, each global token generator may be capable of providing different kernels for different images to be processed, and this way of adaptively generating kernels based on the input may facilitate extracting features of the image patches.

In an embodiment, a kernel generator may be configured to adaptively generate kernels (which may be referred to as an adaptive kernel, or a kernel such as a convolutional kernel) for different inputs. The kernel generator may employ, but is not limited to, convolutional layers, fully connecting layers, etc. It should be understood that, for some cases, it may be equivalent to use convolution layer or a fully connecting layer. For example, when the size of the convolutional layer is 1×1, if the task situation is more complex, larger size of convolutional layers (e.g., 3×3, etc.) may be considered to improve the local perceptual field and to obtain a better adaptive kernel. The adaptive kernel may determine which features in the image patches are more deserving of attention.

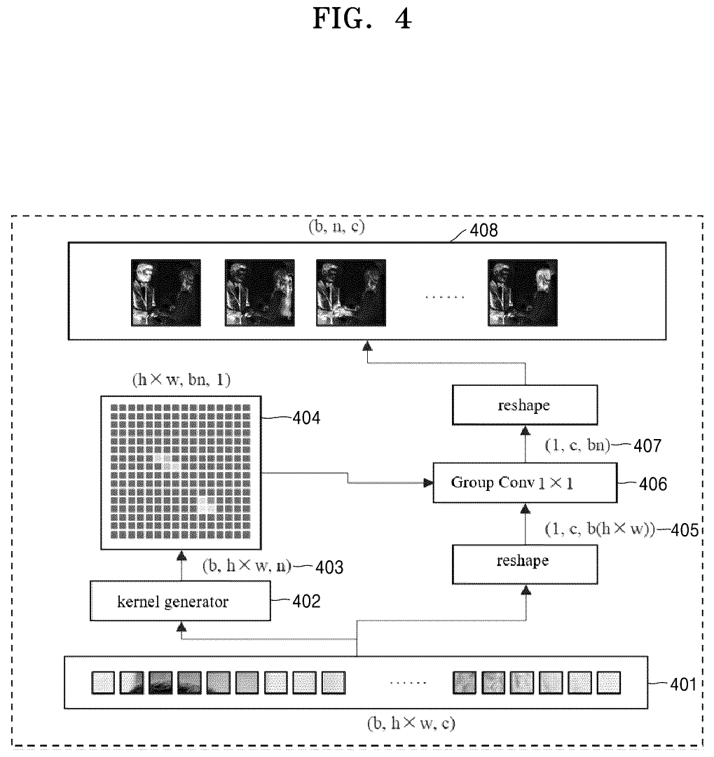

In an embodiment, an example execution flow of a global token generator is illustrated in FIG. 4 which may include the steps of:

(1) Inputting an image patch feature (401), e.g., the same as the input of the cross granularity transformer, which may be referred to above and will not be repeated herein. Here the size of the input is assumed to be (b, h×w, c), wherein b denotes the BatchSize, c denotes the number of channels, and h×w denotes the number of image patches.

(2) Generating, by the kernel generator (402), an adaptive kernel to extract global spatial features. The kernel generator may generate a kernel corresponding to each frame of the image in each batch during the training process as well as during the application process. The kernel generator may output an adaptive kernel (b, h×w, n) (403), wherein n indicates the configured number of global tokens to be extracted. For example, the configured number of global tokens may be configured as n=8 so as to balance the computing amount and the accuracy, but is not limited thereto. The different color depths in the adaptive kernel of the example in FIG. 4 may indicate the degree to which the information attracts attention, e.g., which locations contain spatial information that is more deserving of attention, wherein dark colors indicate relatively unimportant and light colors indicate relatively important.

(3) Reshaping the generated adaptive kernel to (h×w, bn, 1) (404) and using for group convolution (Group Conv) (406).

(4) Extracting, with the generated kernel, spatial features. The input image patches may be reshaped to (1, c, b(h×w)) (405), and then perform a group convolution (e.g., Group Conv 1×1) (406) with the reshaped kernel (h×w, bn, 1) (404), and the group convolution may serve to extract the global token to obtain the global token of (1, c, bn) (407). Since the kernel may be generated adaptively, it may facilitate understanding which features are more important for that input image patch.

(5) Obtaining a series of global tokens (b, n, c) (408) by reshaping the obtained global token.

The global token generator provided in an embodiment may be capable of generating an adaptive kernel that enable extraction of global attention information and local attention information from a high resolution input with lower computing amount, thereby improving the recognition rate of tiny actions.

In an embodiment, Step S1032 may include: determining, via a cross granularity attention network (also referred to as a cross-attention network), attention information among the at least one global token and the second image patches; and obtaining third image patches including global attention information and local attention information; and, determining the recognition result of the image to be processed, based on the third image patches.

For example, Step 1032 may include determining the global attention information among at least one global token and the second image patches; and determining third image patches comprising the global attention information and the local attention information, based on the extracted global attention information and the second image patches comprising the local attention information; and subsequently determining the recognition result of the image to be processed, based on the third image patches.

As shown in FIG. 3c, after determining the at least one global token and the second image patches comprising the local attention information, the attention information between each second image patch comprising the local attention information and each global token may be calculated, so that each second image patch comprising the local attention information may obtain global attention information, and then the third image patches comprising the global attention information and local attention information may be obtained. The non-elaborated aspects of FIG. 3c may be found specifically in the above description of FIG. 3a and FIG. 3b, and will not be repeated herein.

It is understood that the global attention information may include a coarser granularity attention information and the local attention information may include a finer granularity attention information. That is, extracting the global attention information and the local attention information may be understood as extracting cross granularity attention information. Further, the recognition result of the image to be processed may be determined, based on the third image patches from which the cross granularity attention information is extracted.

In an embodiment, by obtaining spatial information in the above manner, the model may be capable of obtaining spatial features with cross granularity attention information while keeping a low computing amount.

Based on the spatial features comprising cross granularity attention information (global attention information and local attention information), the image processing method provided in an embodiment may be capable of achieving an improved recognition rate of tiny actions, and thus may improve the accuracy of a highlight recognition result.

In an embodiment, if output image patches comprising global attention information are obtained by extracting a global token, the computing amount to obtain global attention information may be significantly reduced. Especially when a higher resolution image coding result is applied to, e.g., when there are more image patches, the computing amount to obtain high resolution global attention information may be greatly reduced, thereby more spatial information may be retained at a low computing amount, so as to facilitate recognizing tiny actions.

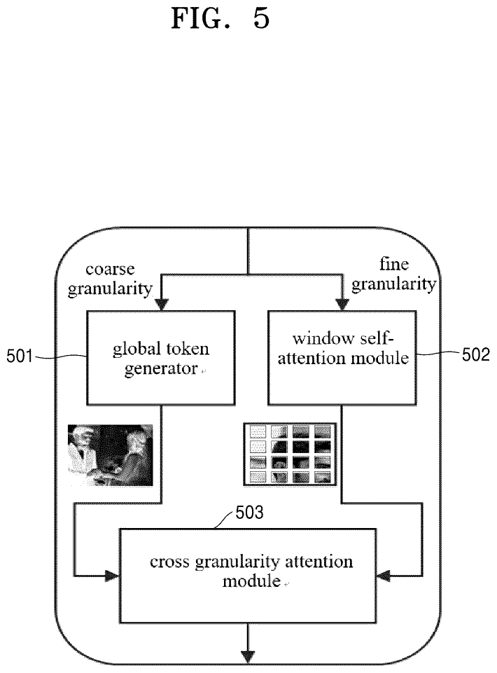

In an embodiment, at least one of the window self-attention network, the global token generator and the cross granularity attention network may be included in a first neural network. In an example, as shown in FIG. 5, the first neural network may include the global token generator (501), the window self-attention network (502) (in the first neural network, which may also be referred to as the window self-attention module) and the cross granularity attention network (503) (in the first neural network In the first neural network, it may also be referred to as the cross granularity attention module). It should be noted that these three parts are not limited to these names, but may also be other names, such as the first module, the second module, the third module, etc. The global token generator (501) may focus on some global information, such as the wedding dress, candlelight, etc. The global token may be extracted by using the global token generator (501), the local attention information may be obtained from the window using the window self-attention module (502), and then the above global token and the local attention information may be combined by using the cross granularity attention module (503). That is, the cross granularity attention module (503) may be based on coarse granularity (global token) and fine granularity (image patches comprising local attention information) features so as to obtain the global attention information. Thus, the model may be capable of extracting information in a high resolution input with a low computing amount so as to facilitate recognizing tiny actions.

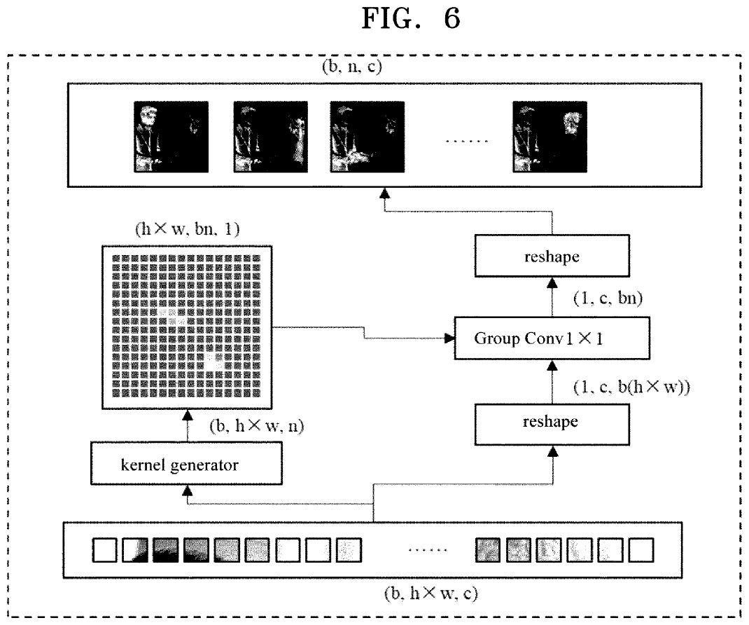

In an embodiment, an example execution process by using the first neural network structure as shown in FIG. 5 is illustrated in FIG. 6, may include the steps in which:

(1) The inputs may include image patch features. Each input image patch may represent a feature at a specific location in the image to be processed; wherein, if the inputs of a first neural network come from the outputs of other networks, the inputs of that first neural network may also contain attention information of other image patches at the same time.

(2) A global token generator may extract a global token from the inputs, and input it to the cross granularity attention module. In an example of a global token, with image patch A shown in the upper left corner of FIG. 6 as an example, it would be known that a man is in a wedding because the wedding dress and wedding ring could provide an attention.

(3) The input image patches may be divided into different windows after the window self-attention module, and the local attention information may be determined among image patches in each window, and the determined local attention information may be added and normalized (Add & Norm) with the input image patches so as to obtain an image patch comprising local attention information, which is input into the cross granularity attention module. In an example of local attention information, taking image patches A-D shown in the upper right corner of FIG. 6 as an example: Without a window self-attention module, it is only known that the image patch A contains an eye. With a window self-attention module, it may be known that the image patch A may get the attention of the image patches B, C, D, and it may be known that the image patch A contains an eye of a man.

(4) The cross-grain attention module may determine the attention information among each image patch and each global token. In this way, the global attention information may be obtained by the image patches. The obtained global attention information may be added and normalized (Add & Norm) with image patches comprising local attention information so as to obtain image patches comprising both global attention information and local attention information. In an embodiment, obtaining the image patches comprising the global attention information and the local attention information, it may also be input into the FFN (Feed Forward Network) for linear mapping, and the linear mapped result and the image patches comprising the global attention information and the local attention information are added and normalized (Add & Norm) again.

(5) An output containing the fine granularity local attention information and the coarse granularity global attention information may be provided for each image patch.

It should be noted that the window self-attention module and cross granularity attention module will form three matrices Q (query), K (key), and V (value) from the input features via three different layers so as to map Q and a series of K-V pairs into outputs by the Attention function.

The network structure provided in an embodiment, which uses coarse and fine features to obtain spatial attention information, may be capable of extracting information in a high resolution input with a low computing amount so as to facilitate recognizing tiny actions.

In an embodiment, determining the recognition result of the image to be processed, based on the first image patches, may include: obtaining fourth image patches comprising global attention information and local attention information, based on the first image patches, via at least one first neural network; and determining the recognition result of the image to be processed, based on the fourth image patches.

That is, in an embodiment, the first image patches may be input to a network comprising the first neural network, for extracting global attention information and local attention information, so as to obtain a series of fourth image patches comprising cross granularity attention information.

In an embodiment, the output fourth image patches may have the same size as the first image patches. In an embodiment, the resolution of the output fourth image patches may be different from the resolution of the first image patches. For example, the resolutions of the first image patches may be adjusted and processed via at least one first neural network so as to extract low-level information at a high resolution and to extract high-level semantic information at a low resolution. The specific resolution may be selected with different values according to different tasks, which is not limited to the embodiment of the present disclosure herein.

Further, upon extracting the local attention information of the image patches via at least one first neural network, the sizes of the windows used by the first neural networks of different layers may be the same or different, and those skilled in the art may configure them according to the actual needs, which is not limited to the embodiment of the present disclosure herein.

In an embodiment, the first neural networks may be connected sequentially using a cascade. For example, the inputs of the first one of the first neural networks may be a predetermined number of first image patches, and the inputs of the other first neural networks may be the outputs of a previous first neural network, and the outputs of the last neural network may be second image patches comprising global attention information and local attention information, but is not limited thereto. The first neural network may also employ other connection structures. For example, it may contain other connection structures such as parallel or residual connection structure.

Further, in addition to the first neural network, the cross granularity transformation network may also include other modules, and the other modules may be extended, and their connection structures with the first neural network may be configured according to the actual situation by those skilled in the art, all of which shall be included in the protection scope of the present disclosure.

It should be noted that the first neural networks may be configured to extract spatial features with cross granularity attention information, so the first neural network may also be referred to as a Cross Granularity Transformer, but the first neural networks are not limited to this name, and may also be other names, such as spatial transformer, etc. Further, the complete model including at least one first neural network may be referred to as Cross Granularity Transformer Network, but is not limited to this name and may be other names as well.

In an embodiment, upon performing the process of obtaining the global attention information and the local attention information, based on the first image patches, via the at least one first neural network, may further comprise: performing at least one down sampling for the first image patches.

That is, in an embodiment, at least one first neural network and at least one down sampling module may be configured to set up the model (cross granularity transformer network), and at least one down sampling module may be configured to obtain different levels of image patch resolutions, and then the first neural network may be configured to extract low-level information, such as lines, colors, directions, etc., at high resolution, but not limited thereto; and to extract high-level semantic information, such as heads, hands, clothes, etc., at low resolution, but not limited thereto. The specific resolution may be selected with different values according to different tasks, which are not limited by the present disclosure. In an embodiment, the output of each one of the first neural networks may be an image patch feature that has the same size as a size of the inputs, and the sizes of image patches may be changed by the down sampling module.

Each down sampling may comprise: down sampling each of the output image patches of a previous first neural network so as to get down sampled results; and functioning the down sampled result as the input image patches of a next first neural network.

That is, each down sampling module may be configured between any two first neural networks, such that the sizes of the input image patches of the first neural network connected to the outputs of the down sampling module are changed, so as to extract higher-level semantic information.

The multiple of each down sampling may be configured according to the actual situation, where the multiples of the down samplings of different down sampling modules may be the same or different, and the present disclosure will not be limited thereto.

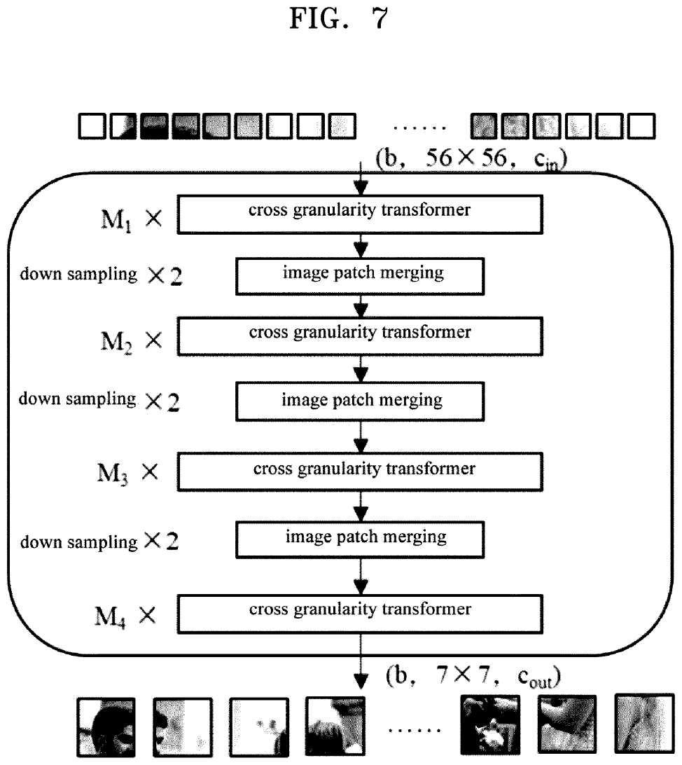

In an embodiment, an example of an execution flow of a cross granularity transformer network is illustrated in FIG. 7 with an input size of (b, 56×56, c_in), wherein b indicates the batch size, 56×56 indicates the number of image patches, and c_in indicates the number of input channels, comprising:

(1) extracting the spatial information of the image using M1 first neural networks. The use of the first neural networks may not change the size of the input image patches; the specific embodiment is described above and will not be repeated herein.

(2) using a down sampling method to perform down sampling by a multiple of 2.

(3) continuing to use M2 first neural networks to extract the spatial information of the image, and then use a down sampling method to reduce the image size.

(4) by analogy, taking each down sampling size as a multiple of 2, wherein, the optional values of M1, M2, M3, and M4 are 2, 2, 6, and 2, but are not limited thereto. The size of finally obtained outputs is (b, 7×7, c_out), where c_out indicates the number of output channels, and c_in and c_out may be the same or different, which is not limited to the present disclosure.

The cross granularity transformer network structure provided in an embodiment may consider both recognition accuracy and computing amount, and may realize that global attention information and local attention information may be extracted from high resolution inputs at a low computing amount, and thus improving the recognition rate of tiny actions.

In an embodiment, a exemplary implementation is provided for the embodiment of the down sampling method. Image patch merging (also known as Patch Merging) may be used for down sampling. That is, for each of the output image patches of a previous first neural network, each of the output image patches (i.e., the input feature maps of the down sampling module) may be down sampled, which may include: grouping feature points of each of the output image patches into grouped feature maps; and concatenating the grouped feature maps in a channel dimension to obtain connected feature maps; and in an embodiment, adjusting the number of channels of the connected feature maps by a predetermined by a predetermined multiple.

In an example application, those skilled in the art may configure the predetermined multiple for reducing the number of channels according to the situation, and the present disclosure are not limited thereto.

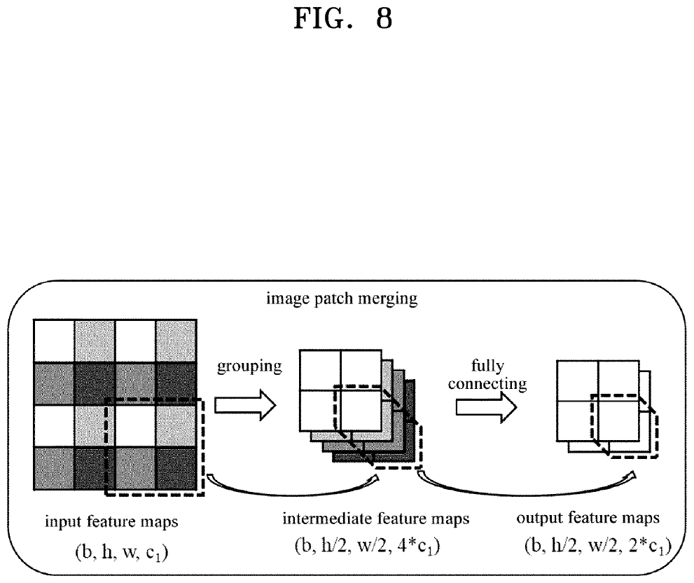

For example, if the predetermined multiple is ½, assuming that the feature size of the image patches (input feature maps of the down sampling module) for image patch merging is (b, h, w, c1), the size of the features (output feature maps of the down sampling module) obtained by image patch merging will become (b, h/2, w/2, c2). As shown in FIG. 8, the specific processing flow may include:

(1) Grouping the input feature maps. In an embodiment, adjacent feature points may be grouped into different groups. For example, every other feature point in both h and w dimensions may be grouped into the same group, then down sampling may be achieved. In an embodiment, feature points of one color may be grouped into the same group. In practice, other grouping methods may also be used, and the present disclosure is not limited thereto. In the example in FIG. 8, the feature points of the feature maps (b, h, w, c1) are grouped into four groups according to the colors, and four groups of feature maps (b, h/2, w/2, c1) are obtained.

(2) Concatenating the four groups of feature maps obtained in a channel dimension, that is, the obtained intermediate feature maps of (b, h/2, w/2, 4*c1).

(3) In an embodiment, adjusting the number of channels. For example, the number of channels may be reduced ½, i.e., channel 4*c1 may be reduced to 2*c1, so as to obtain the output feature maps of (b, h/2, w/2, 2*c1), i.e., c2=2*c1. In practice, the predetermined multiple of the number of channels that is adjusted is not limited thereto, but may also be other values. In an embodiment, this step may use a fully connecting layer, or other means may be used, which is not limited to the present disclosure herein.

In comparison with an average pooling down sampling method or a maximum pooling down sampling method, the image patch merging method used in an embodiment may be capable of reducing the loss of information and ensure the richness of information as much as possible.

In an embodiment, the extracted third image patches comprising global attention information and local attention information may be further extracted to obtain temporal (time) information. That is, the step of determining the recognition result of the image to be processed, based on the third image patches, may comprise: determining fifth image patches comprising global attention information, local attention information and temporal information, based on the third image patches; and determining the recognition result of the image to be processed, based on the fifth image patches.

In some applications, those skilled in the art may select a suitable temporal information extraction method according to the actual situation, which is not limited to the present disclosure herein.

The image processing method provided in an embodiment may separate the obtaining modules of spatial information and temporal information to facilitate processing speed.

Some embodiments may provide for extracting temporal information. Fifth image patches comprising global attention information, local attention information and temporal information may be determined based on the third image patches, via a second neural network. That is, the third image patches comprising the global attention information and the local attention information may be prepared for inputting into the second neural network for further extracting the temporal information.

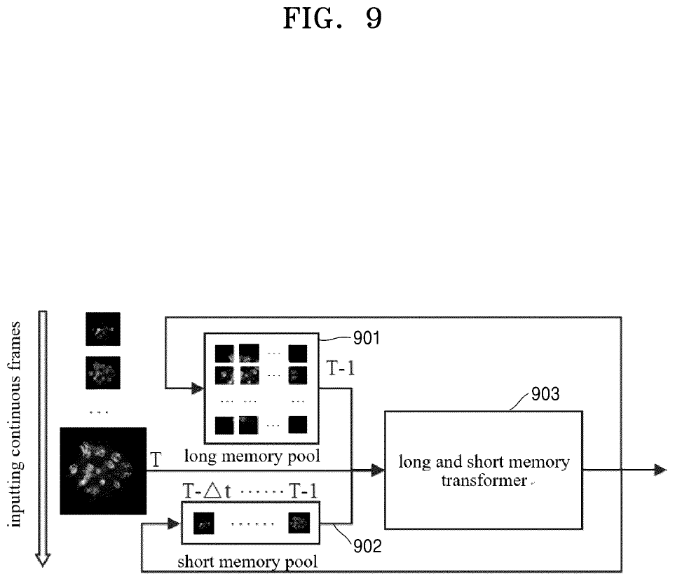

As shown in FIG. 9, the second neural network may comprise a long memory pool (901), a short memory pool (902), and a long and short memory transformer (903) (which may be collectively referred to as a Temporal Memory Transformer). Long memory information with coarse granularity, of NF frames of images may be retained in a long memory pool (corresponding to frame T−Δt, . . . , frame T−1 of a long memory pool (901) in FIG. 9, wherein Δt=NF). And short memory information with fine granularity, of NC frames of images may be retained in a short memory pool (corresponding to frame T−1 of a short memory pool (902) in FIG. 9, but not limited to this frame), wherein NFNC. The long memory transformer and the short memory transformer may be configured to extract information with different temporal granularity. That is, the long and short memory information in the long and short memory pool may be configured to assign the temporal content of the current frame T to be processed.

The third image patches comprising global attention information and local attention information, as well as long memory information and short memory information in the long memory pool and the short memory pool, may be input into the long memory transformer and the short memory transformer for extracting long and short temporal information so as to obtain the highlight recognition result of the image to be processed.

By using this method, the model may be capable of obtaining temporal information even when using one frame T of the image to be processed, when processing the input of consecutive frames; and obtaining the highlight recognition result of one single frame of the image to be processed, reducing the time of a single run and enabling the model to operate in a mobile device.

It should be noted that since the second neural network is based on the long memory pool (901) and the short memory pool (902) for extracting long temporal features and short temporal features, the second neural network may also be referred to as Temporal Memory Transformer Network (TMTN), but the second neural network is not limited to this name, but may also be other names. Similarly, the names such as Long and Short Memory Transformer, Temporal Memory Transformer should not be construed as a limitation of the network, and these networks may be other names as well.

In other words, the above step of “determining the fifth image patches comprising global attention information, local attention information and temporal information, based on the third image patches, via the second neural network” may comprise:

Step SA: obtaining, from the predetermined short memory pool, sixth image patches corresponding to at least one frame of the processed image prior to the image to be processed; and determining the third image patches comprising the global attention information, the local attention information and the temporal information (e.g. “processed third image patches), based on the third image patches and the sixth image patches.

In an embodiment, the second neural network may include at least one short memory transformer, and in this step: the third image patches comprising the global attention information and the local attention information and the temporal information, may be determined by the at least one short memory transformer, based on the third image patches comprising the global attention information and the local attention information and the sixth image patches.

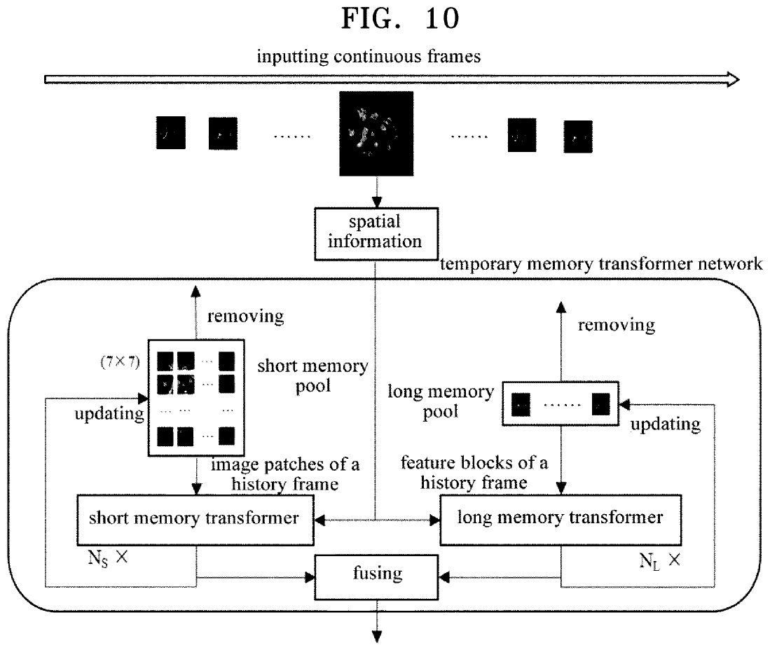

As shown in FIG. 10, the sixth image patches (image patches of a history frame) corresponding to at least one frame of processed image prior to the image to be processed may be obtained from the predetermined short memory pool. Each sixth image patch comprises features representing spatial information and temporal information at a specific location in the previous one or more frames. The sixth image patches may be a feature with the same size as the third image patches. For example, if the output image patches shown in FIG. 7 have a size of 7×7 as an example, the sixth image patches corresponding to each frame of the processed image in the short memory pool may also have a size of 7×7. In an embodiment, the sixth image patches may be a feature of a different size from the third image patches. In this case, the obtained sixth image patches may be transformed to features with the same size as the third image patches comprising global attention information and local attention information before extracting the short temporal information.

In an embodiment, based on the consideration of accuracy and computing amount, only the sixth image patches corresponding to one frame of the processed image may be retained in the short memory pool. In practice, those skilled in the art may configure the number (i.e., the above NC) of frames of processed images retained in the short memory pool according to the actual situation, which is not limited to the present disclosure.

Further, the sixth image patches corresponding to at least one frame of the obtained processed image and the third image patches comprising global attention information and local attention information (i.e., comprising spatial information) may be passed through NS short memory transformers so as to output short temporal features, i.e., the third image patches comprising global attention information, local attention information and temporal information, for performing Step SC.

Furthermore, the output short temporal features may be configured to update the short memory pool. That is, the short memory pool may be updated whenever the image to be processed is processed. The short memory pool may be updated based on the third image patches comprising global attention information, local attention information, and temporal information. For example, when the short memory pool is updated, a new short temporal feature may be added to the short memory pool; and when the number of frames of processed images retained in the short memory pool exceeds a predetermined value, an oldest feature may be removed from the short memory pool.

Step SB: down sampling the third image patches to obtain seventh image patches; obtaining, from a predetermined long memory pool, eighth image patches respectively corresponding to at least one frame of a processed image prior to the image to be processed; and determining the seventh image patches comprising temporal information, based on the seventh image patches and the eighth image patches.

An embodiment may include down sampling the third image patches comprising global attention information and local attention information (i.e., comprising spatial information). That is, fine granularity features may be transformed to coarse granularity features so as to enhance the temporal features in the image to be processed by using the different coarse and fine features in order to obtain the seventh image patches. It is understood that the seventh image patches may also be image patches comprising global attention information and local attention information. The seventh image patches may be down sampled to a feature with a size of 1×1, i.e., a feature representing one video frame. Other sizes may be used, and the present disclosures is not limited thereto.

Continuing as shown in FIG. 10, at least one eighth image patch respectively corresponding to at least one processed frame prior to the image to be processed, may be obtained from a predetermined long memory pool. Each eighth image patch may include the temporal features of all previous frames prior to the image to be processed. The eighth image patches may be a feature with the same size as the seventh image patches, e.g., all features with a size of 1×1, i.e., features representing one video frame, and then the eighth image patches may be history feature maps. In an embodiment, the eighth image patches may be features with a different size from the seventh image patches. In this case, the obtained eighth image patches may be transformed to features with the same size as the seventh image patches, before extracting the long temporal information.

In some applications, those skilled in the art may configure the number (i.e., the aforementioned NF or At) of frames of processed images retained by the long memory pool according to the actual situation, and the present disclosure is not limited thereto.

In an embodiment, the second neural network may include at least one long memory transformer, and in this step, the seventh image patches comprising the temporal information may be determined based on the seventh image patches and the eighth image patches by the at least one long memory transformer.

The eighth image patches and the seventh image patches respectively corresponding to the obtained at least one frame of the processed image, may be passed through the NL long memory transformers, and the NL long memory transformers output long temporal features. That is, the seventh image patches comprising global attention information, local attention information, and temporal information, may be outputted for performing step SC.

Furthermore, the output long temporal features may be configured to update the long memory pool. That is, the long memory pool may be updated whenever the image to be processed is processed. In some examples, the long memory pool may be updated based on the seventh image patches comprising the temporal information. For example, when the long memory pool is updated, a new long temporal feature may be added to the long memory pool; and when the number of frames of processed images retained in the long memory pool exceeds a predetermined value, an oldest feature may be removed from the long memory pool.

In some applications, those skilled in the art may configure the number NS of short memory transformers and the number NL of long memory transformers according to the actual situation. In an embodiment, NS and NL may be the same or different, and the present disclosure is not limited thereto.

Step SC: obtaining the fifth image patches comprising global attention information, local attention information and temporal information, based on the third image patches comprising the global attention information, the local attention information and the temporal information and the seventh image patches comprising the temporal information.

In an embodiment, the short temporal features outputted by step SA and the long temporal features outputted by step SB may be fused, and the fused result may be output. That is, the fifth image patches comprising the global attention information, the local attention information and the temporal information, may be outputted.

Further, the final result, i.e., the recognition result of the image to be processed, may be obtained based on the fused result.

The temporal information extraction method provided in the embodiment may be capable of obtaining temporal information by using only one single frame when the inputs are continuous single frames of a video, and reduces the time of a single run and makes it possible to run the model on an edge device. In addition, the second neural network may use long memory information with coarse granularity, and short memory information with fine granularity, to enhance the temporal features in the image to be processed so as to ensure that sufficient temporal information is obtained, in order to achieve the desired recognition effect.

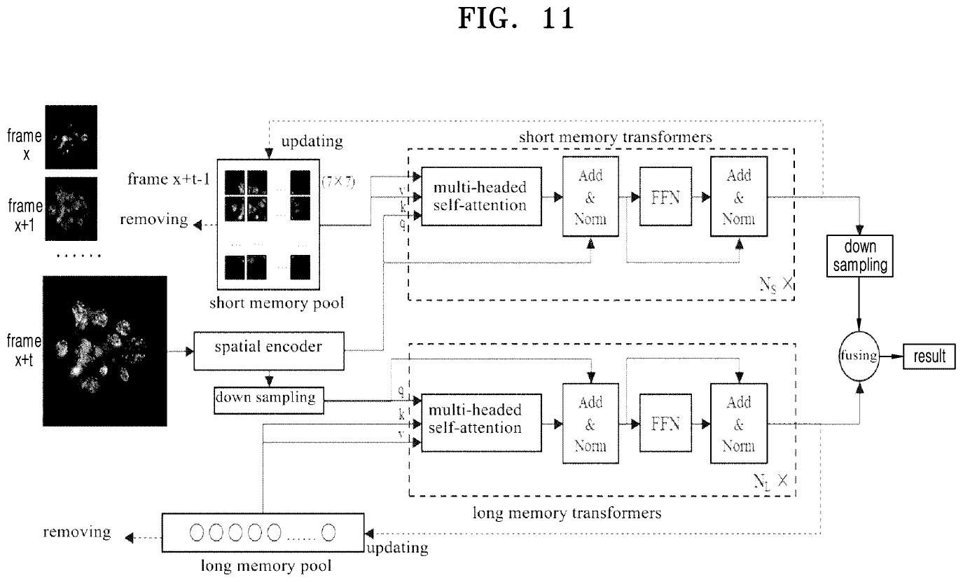

In an embodiment, an example execution flow of a second neural network is illustrated in FIG. 11, taking processing a single video frame as an example, comprising the steps of:

(1) The inputs are image patches (i.e., third image patches comprising global attention information and local attention information) with obtained spatial information, which are output by a spatial transformer according to the current frame (frame x+t) to be processed. And frame x, frame x+1, . . . , and frame x+t−1 are all processed video frames.

(2) The long memory pool may retain a certain number of coarse granularity tokens (i.e., the eighth image patches, obtained from the processed video frames). Each token may represent the features of one video frame, and contain all the temporal features prior to the current frame to be processed, and may be configured to obtain long temporal information for the current frame to be processed. The image patches with obtained spatial information may be down sampled and processed with the token in the long memory pool by NL long memory transformers so as to obtain the long temporal features. In an embodiment, each long memory transformer may comprise a multi-headed self-attention module, an adding and normalizing (Add & Norm) module in a residual connection, an FFN module, and yet another adding and normalizing (Add & Norm) module in a residual connection.

(3) The short memory pool may retain fine granularity tokens of the previous frame (frame x+t−1), which may comprise, for example, 7×7 tokens. Each token may represent a certain image patch comprising spatial and temporal information, in a previous frame, and is configured to obtain short temporal information for the current frame to be processed. The image patches with the obtained spatial information and the tokens in the short memory pool are processed through NR short time memory transformers so as to obtain short temporal features. In an embodiment, the structure of each short memory transformer may be the same as or different from the long memory transformer. For example, each short memory transformer may also include a multi-head self-attention module, an adding and normalizing (Add & Norm) module in a residual connection, an FFN module, and yet another adding and normalizing (Add & Norm) module in a residual connection.

(4) Whenever a video frame is processed, the long memory pool and the short memory pool may be updated. When the long memory pool and the short memory pool are updated, a new token is added to the memory pool and an oldest feature is removed from the pool.

(5) The short features may be down sampled (either may be down sampled to the same size as the long temporal features, e.g., 1×1, or may be down sampled to other sizes), and then fused with the long temporal features, so as to obtain the final result.

It should be noted that the multi-headed self-attention module in the long memory transformer and the short memory transformer may form three matrices Q (query), K (key), and V (value) from the input features via three different layers, in order to map Q and a series of K-V pairs into the outputs by the Attention function.

In addition, more about FIG. 11 may be found in the description of FIGS. 9 and 10 above and will not be repeated herein.

In some applications, online video recognition tasks usually require running results of a quickly obtained model, and the inputs are usually a fixed number of video frames, in order to collect temporal information. Due to the limitation of the number of input video frames, a general method takes a long time for calculating per run, and thus results in poor real-time performance.

However, some embodiments of the present disclosure separately design the spatial and temporal obtaining modules so as to facilitate speedup. The model may use only one video frame input per run, while still maintaining enough temporal information.

The second neural network provided in an embodiment may be capable of significantly reducing the latency of the model, so as to allow the model to run in real time in a mobile device.

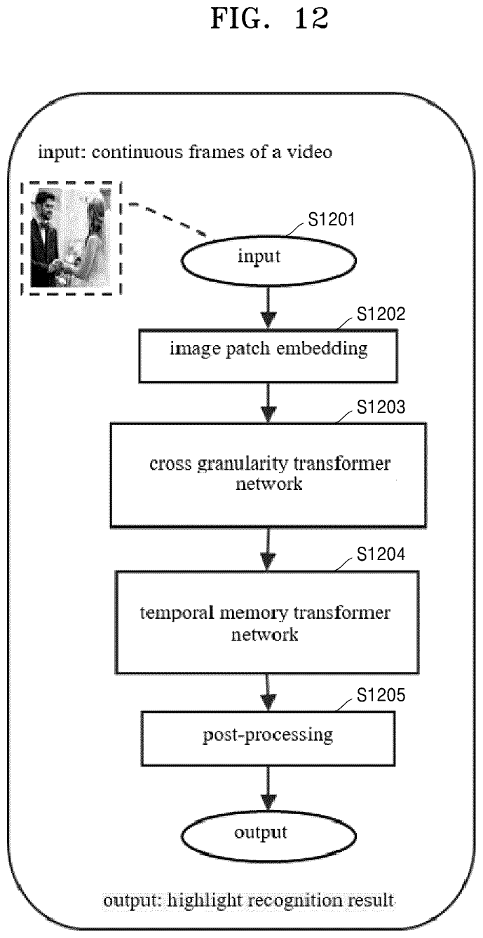

Based on at least some embodiments, a complete example of a highlight recognition method is provided in FIG. 12. The highlight recognition may include a network of cross granularity transformers capable of obtaining global attention information and local attention information; and a network of temporal memory transformers capable of obtaining temporal information when the inputs are continuous single frames of a video. A flow of the method is as follows:

(1) S1201: The inputs may be continuous frames of a video (which may be sampled by a certain sampling method), and an input per run may be 1 frame of image. In an embodiment, the input 1 frame of the image may be an RGB image or in other formats.

(2) S1202: The input images may be encoded into a fixed number of image patches (patches) by using image patch embedding (Patch embedding). For example, a convolutional layer may be used. The input images may be encoded into image patches with a higher resolution.

(3) S1203: The patches may be input into a network consisting of cross granularity transformers (one or more) so as to extract global attention information and local attention information, and thus a series of patches with extracted spatial information may be obtained.

(4) S1204: The series of patches with extracted spatial information may be input to the network composed of temporal memory transformers (one or more), thereby performing an extraction for long temporal information and short temporal information, and integrating the spatial information so as to obtain the highlight recognition result of one single frame.

(5) S1205: After obtaining the highlight recognition result of each frame, the process may be post-processed in a method such as pyramid sliding window, so as to obtain the start time point and the end time point of the highlight recognition.

The non-elaborated point about FIG. 12 may be referred to the description of the above embodiments, and will not be repeated herein.

The highlight recognition method provided in some embodiments may achieve real-time operation by extracting spatial and temporal global attention information and local attention information from a higher resolution input while using one single frame as input, and thus may be reliably applied to mobile devices.

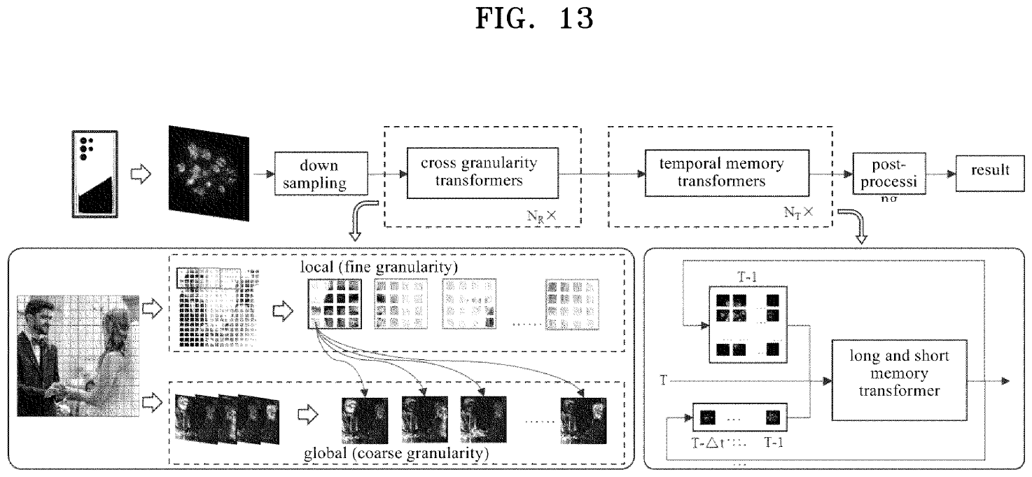

As shown in FIG. 13, an embodiment may provide a complete example of a highlight recognition method capable of being implemented on a mobile device. The highlight recognition method may include NR cross granularity transformers capable of obtaining global attention information and local attention information; and the highlight recognition method may include NT temporal memory transformers capable of obtaining temporal information in a case where the inputs are continuous single frames of a video (also referred to as the long memory transformer and the short memory transformer in FIG. 13). The flow of the method is as follows:

(1) The mobile device may obtain continuous frames of images of a video.

(2) The mobile device may input 1 video frame per run as an image to be processed.

(3) The image to be processed may be down sampled, e.g., by encoding the input image into a fixed number of image patches by using image patch embedding.

(4) The image patches may be input into NR cross granularity transformers, for extracting global attention information and local attention information; and a series of patches with extracted spatial information may be obtained, wherein the processing process of each cross granularity transformer is described above and will not be repeated herein.

(5) A series of patches with extracted spatial information may be input into NT temporal memory transformers; and long temporal information and short temporal information may be extracted based on the long memory pool and the short memory pool; and spatial information may be integrated to obtain the highlight recognition result of the image to be processed, where the processing process of each cross granularity transformer is described above and will not be repeated herein.

(6) After obtaining the highlight recognition result of each frame, the post-processing process, such as pyramid sliding window, may be configured to obtain the start time point and the end time point of the highlight recognition, and then the highlight snippets of the video may be obtained.

The model architecture provided in an embodiment may have a smaller model size, a smaller computing amount, a higher accuracy, and may run in real time, which may overcome the limitation of memory and computing capacity of the mobile device and thus may realize the recognition task of highlight video with a lower consumption of computing resources.

In an embodiment, after obtaining a continuous frame image of a video, the video may be pre-processed first; and then the model may be ran to input the pre-processed image, for processing.

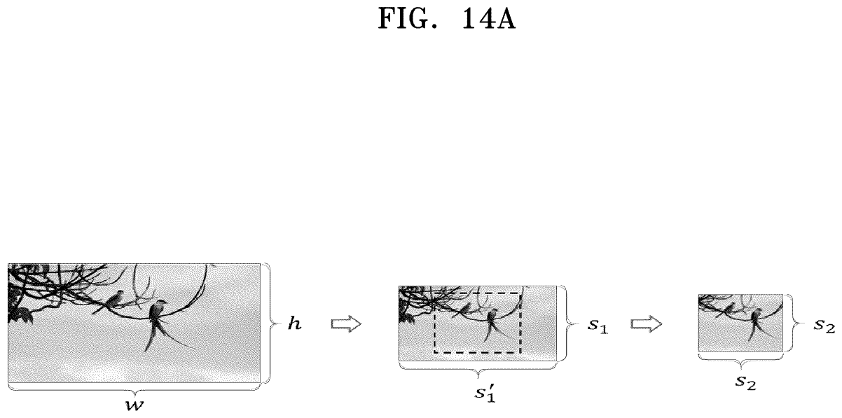

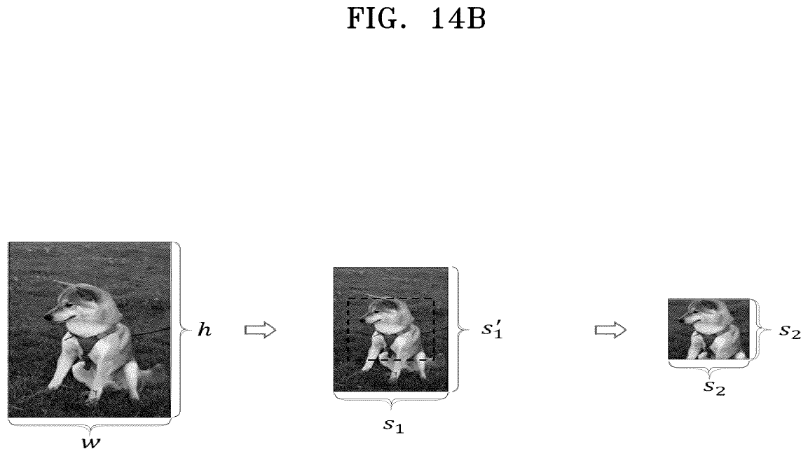

In an embodiment, the various formats of the video frame images obtained by different means may be transformed to an RGB format in a uniform manner. After obtaining the RGB image, the image may be resized. For example, the short side of the image (width w, height h) may be reduced to a fixed size s₁, and the long side of the image may be reduced to s₁′ according to the following formula (Math FIG. 1), as shown in FIG. 14a (w is the long side, h is the short side) and FIG. 14b (w is the short side, h is the long side).

$$\{ \begin{matrix}l = min ( h , w ) \\ ratio = {s}_{1} / l \\ {s}_{1}^{′} = max ( h , w ) * ratio\end{matrix} \qquad [ Math Figure 1 ]$$

After changing the image size, the image may be reshaped, for example, with a positive central origin, a square part of s₂×s₂ is intercepted in the image as an input to the next level of the network. Wherein, the sizes of s₁, s₁′ and s₂ may be configured according to actual needs, which is not limited to the present disclosure.

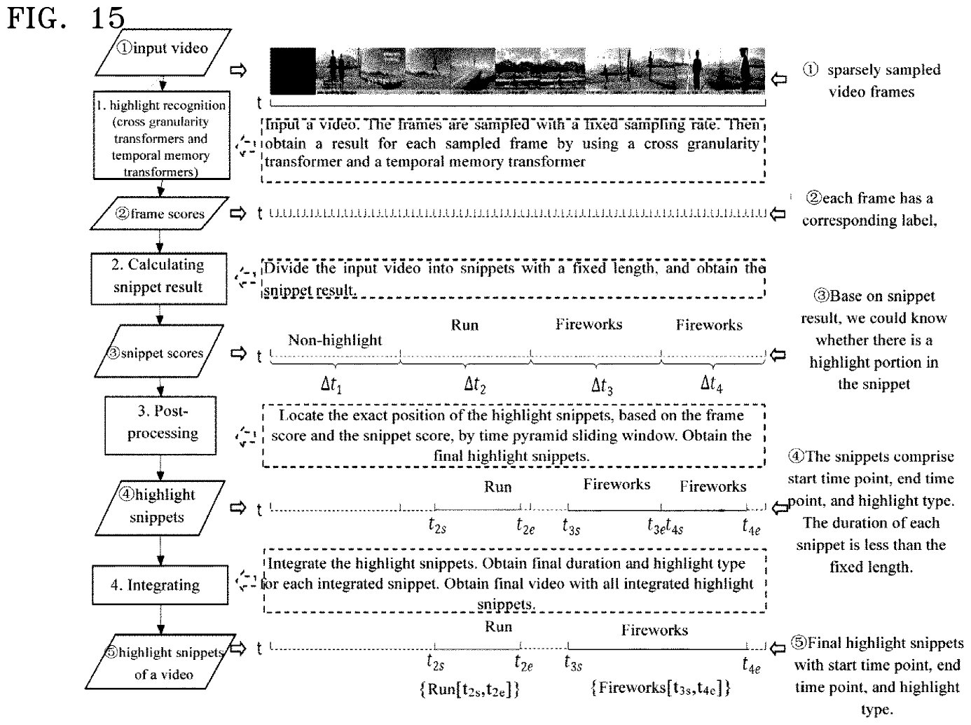

Further, as shown in FIG. 15, an embodiment is illustrated by an example including the following processing flow:

(1) An input video may be obtained after the above processing continuous frames of a video (sparsely sampled video frames are used as an example in FIG. 15).

(2) Each frame of the input video may be successively performed for a highlight recognition as the image to be processed. For processing each frame of the image to be processed, the image to be processed may be down sampled into a series of image patches by using a fixed sampling rate; and the global attention information and local attention information may be obtained by a cross granularity transformer; and the temporal information may be obtained by a temporal memory transformer, so as to obtain the highlight recognition score for each frame. Each frame may have a corresponding label, which represents which type the frame will be predicted as.

(3) The input video may be divided into snippets with a fixed length, and a score of each snippet is calculated. The recognition result of each snippet may be used to know whether each snippet contains a highlight portion or not. For example, 4 snippets may be obtained in this example, wherein Δt1 corresponds to no highlight result, Δt2-Δt4 correspond to different types of highlight results respectively.

(4) In the post-processing stage, by the time pyramid sliding window method, an exact position of the highlight snippets (including the start time point and the end time point) may be located, according to the highlight recognition score of each frame and the score of each snippet. For example, 3 highlight snippets are obtained in this example, corresponding to the exact positions of the clips [t2s, t2e], [t3s, t3e] and [t4s, t4e], wherein, the duration of each snippet is no longer than the fixed length of the above divided snippets.

(5) The highlight snippets may be integrated. If the highlight snippets are of the same type, and the clips of two highlight snippets are adjacent, the two highlight snippets may be integrated into one highlight snippet. In this example, the clip corresponding to the integrated highlight snippet is [t3s, t4e], then, the highlight results corresponding to this input video are two types of highlight snippets, corresponding to the clips [t2s, t2e] and [t3s, t4e], respectively.

The highlight recognition method provided in an embodiment may be applied to offline and/or online processing, and may be applied in terminal devices such as a smartphone and a tablet, and also may be applied in servers. Wherein:

(1) offline processing: a certain video may be selected among the stored videos for highlight recognition processing; and after processing is completed, a plurality of video highlight snippets are obtained. And the video highlight snippets may be selected for saving, analyzing, editing or sharing, and other operations.

(2) online processing: video contents may be real-time highlight recognized, in the process of recording video; and after recording is completed, a plurality of video highlight snippets may be obtained. In the same way, the video highlight snippets may be selected for saving, analysis, editing or sharing and other operations.

The cross granularity transformer module provided in an embodiment may improve the recognition rate of tiny actions while keeping the computing amount low. When compared with the existing models, the accuracy rate of the existing models is 92.2%, while the accuracy rate of the model provided in an embodiment is 95.3%. In the recognition of tiny actions, the model provided in an embodiment is more effective. For example, the accuracy of the existing models is 0.897 for a tiny action of cutting a cake, while the accuracy of the model provided in an embodiment is 0.916; and for the tiny action of blowing a candle, the accuracy of the existing models is 0.922, while the accuracy of the model provided in an embodiment is 0.953.

In terms of computing amount, the computing amount of an existing transformer module may include:

$$Ω ( GT ) = 4 hw {C}^{2} + 2 {( hw )}^{2} C \qquad [ Math Figure 2 ]$$

The computing amount of the cross granularity transformer module provided in an embodiment may include:

$$Ω ( CGT ) = ( 6 hw + 2 n ) {C}^{2} + ( 2 {M}^{2} + 4 n ) hw C \qquad [ Math Figure 3 ]$$

where h and w correspond to the resolution of the input image patch, n corresponds to the number of global tokens, M corresponds to the side length of the window (which may be used in the window self-attention module). For example, if M=7, the window size is configured to 7×7 and C corresponds to the number of channels; if h=w=56, n=8, M=7, in general, the value of C corresponding to a large model is 768. Then, Ω(GT) and Ω(CGT) may be determined based on Math FIGS. 2 and 3, and the values are Ω(GT)=22.5G and Ω(CGT)=12.1 G. The computing amount is nearly ½. For edge devices, the number of channels is even lower and the reduction in computing is even greater. For example, when the number of channels is 320, Ω(GT)=7.57 G and Ω(CGT)=2.06 G, which reduces the computing by nearly ¼.

Further, when compared with existing related models, the result shows that the cross granularity transformer has a higher accuracy and a smaller model size.

The temporal memory conversion module provided in an embodiment may be capable of extracting both long temporal information and short temporal information while the input is one frame of a video frame. The spatial information indicates what objects are in the video frame, while the temporal information may describe what is happening in the video. Typically, inputting 32 frames takes hundreds of milliseconds to process, while inputting one single frame takes only a few tens of milliseconds. This makes it possible to run the model in a mobile device.

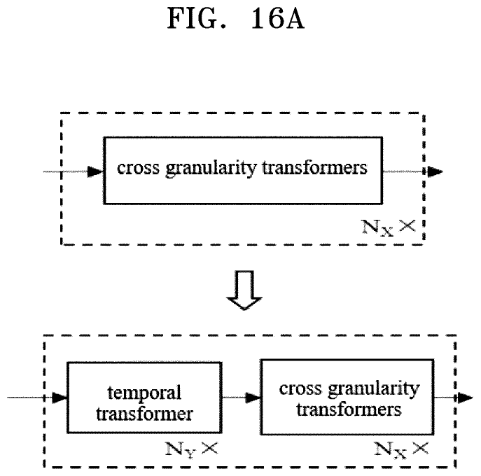

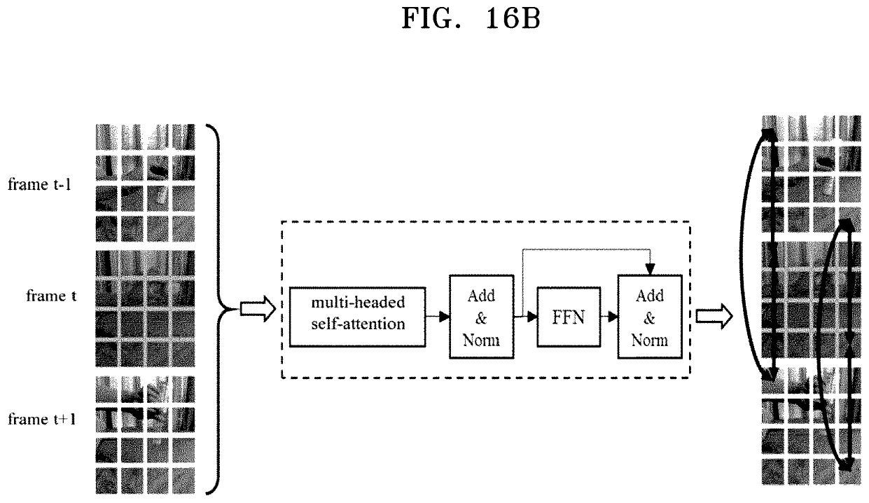

In an embodiment, a method of extracting temporal information is also provided, by using a temporal transformer (another option for the second neural network) to obtain temporal information from a fixed number of frames. For example, as shown in FIG. 16a, NY temporal transformers are added to NX cross granularity transformers. That is, extracting temporal information and spatial information may be performed by a network consisting of NY temporal transformers and NX cross granularity transformers. For example, the NY temporal transformers and the NX cross granularity transformers may be connected in sequence. In this connection case, the first image patches corresponding to the image to be processed obtained in Step S101 are the first image patches comprising temporal information output by the NY temporal transformers. In some embodiments, other connection methods may also be used. As well, the present disclosure may not specifically limit the number of temporal transformers NY and the number of cross granularity transformers NX here, which may be configured by those skilled in the art according to actual needs. In an embodiment, NY=NX, or NY is not larger than NX. wherein the cross granularity transformers are referred to the above description and will not be repeated herein.

For processing the temporal transformer, as shown in FIG. 16b, the steps may include the following steps in which:

(1) The inputs may be image features with a fixed number of frames, and the number of input frames is 3 in this example.

(2) The temporal transformers may exchange information among the same spatial locations of different frames. In an embodiment, each temporal transformer may comprise a multi-headed self-attention module, an adding and normalizing (Add & Norm) module in a residual connection, an FFN module, and yet another adding and normalizing (Add & Norm) module in a residual connection. The temporal sense further corresponds to the serial number of the input frame. That is, only one temporal transformer may have access to the global temporal information.

(3) The outputs may be the image patch features with temporal information. Each image patch may obtain temporal information at the same spatial location and the outputs may have the same size as the inputs.

The temporal information extraction method provided in an embodiment may be easy to train and the structure may be easily inserted into different models with high flexibility.

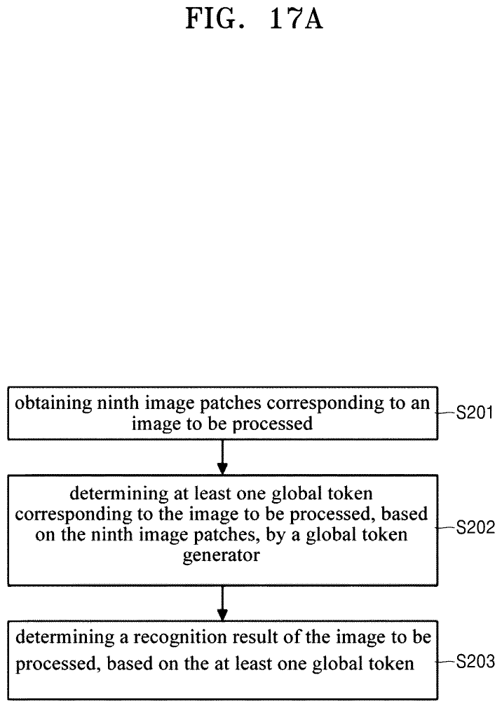

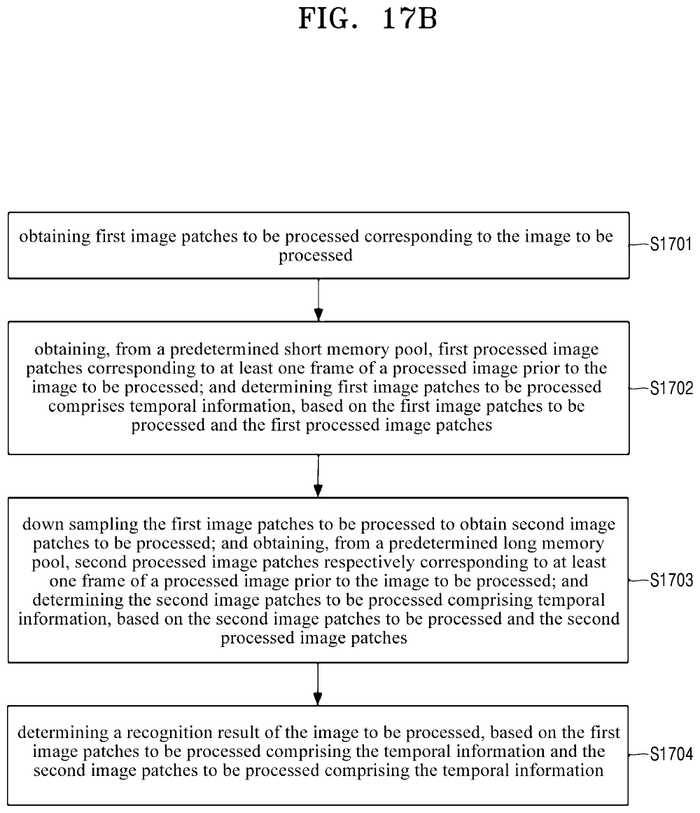

An image processing method provided in an embodiment shown in FIG. 17a may include:

Step S201: obtaining ninth image patches corresponding to an image to be processed.

The description of this step may be similar to step S101, which will not be repeated herein.

Step S202: determining at least one global token corresponding to the image to be processed, based on the ninth image patches, by a global token generator.

In an embodiment, the global token generator may extract a group of global tokens from the ninth image patches. Each global token may be a representation of an image patch for information, and may be capable of representing global (coarse granularity) semantic (attention) information of the entire image to be processed. The global attention information may focus on feature information of the entire image to be processed, such as, but not limited to, what items are present at what locations in the figure, etc. Further, the global attention information may also be understood as spatial information. Different global tokens may focus on different spatial information.

In an embodiment, the number of global tokens extracted by the global token generator may be configured according to the actual situation, and the present disclosure is not limited thereto.

In an embodiment, the global token generator may include a kernel generator, the step may include: generating at least one kernel for the image to be processed by the kernel generator; determining at least one global token respectively corresponding to the at least one kernel, based on the at least one kernel and the ninth image patches.

In an embodiment, the used kernels may not have a fixed weight, i.e., each global token generator may be capable of providing different kernels for different images to be processed, and this adaptive generation of kernels based on the input facilitates extracting features of the image patches.

In an embodiment of the present disclosure, a kernel generator may be configured to generate kernels adaptively for different inputs. The kernel generator may employ, but is not limited to, convolutional layers, fully connecting layers, etc. It may be understood that for some situations, the use of a convolution layer and a fully connecting layer may be equivalent, for example when the size of the convolutional layer is 1×1. If the task situation is more complex, convolutional layers with a larger size (e.g., 3×3, etc.) may be considered to improve the local perceptual field and to obtain a better adaptive kernel. The adaptive kernel may determine which features in the image patch are more deserving of attention. As an example, the execution process of a global token generator is described with reference to FIG. 4 and will not be repeated herein.

The first neural network provided in an embodiment may be capable of generating an adaptive kernel that allows global attention information and local attention information to be extracted from a high resolution input at a low computing amount, thereby improving the recognition rate of tiny actions.

Step S203: determining a recognition result of the image to be processed, based on the at least one global token.

The window self-attention network may be configured to divide the ninth image patches into at least two groups, and for each group of the ninth image patches, the attention information among the ninth image patches in each group may be determined respectively to obtain tenth image patches comprising local attention information; and then the recognition result of the image to be processed may be determined based on the at least one global token and the tenth image patches.

The local attention information among the ninth image patches in each group of the ninth image patches may be extracted respectively for each group of the ninth image patches; and the tenth image patches may be determined based on the ninth image patches and the extracted local attention information.

The local attention information may focus on the feature information among the attention to different image patches. For example, an image patch may be associated with determining the content in an image patch after attracting the attention of other image patches, but is not limited thereto. Further, the local attention information may be understood as spatial information.

In an embodiment, the window self-attention network may divide the ninth image patches into different windows, and the local attention information may be determined among the image patches in each window. In an embodiment, the size of the windows (i.e., the side length of each window or the number of image patches in each window) may be configured according to the actual situation, and the present disclosure is not limited thereto.

An embodiment may include determining the attention information among the at least one global token and the tenth image patches, via a cross-attention network (or referred to as a cross granularity attention network); and obtaining eleventh image patches comprising global attention information and local attention information; and determining the recognition result of the image to be processed, based on the eleventh image patches.

The global attention information among at least one global token and the tenth image patches may be determined; and the eleventh image patches comprising the global attention information and the local attention information may be determined based on, the tenth image patches comprising the local attention information and the extracted global attention information; and subsequently, the recognition result of the image to be processed may be determined, based on the eleventh image patches.

It may be understood that the global attention information may be coarser granularity attention information and the local attention information may be finer granularity attention information. That is, the extraction of the global attention information and the local attention information may be understood as the extraction of the cross granularity attention information. Further, the recognition result of the image to be processed may then be determined based on the eleventh image patches from which cross granularity attention information is extracted.

Non-elaborated details of the embodiments of the present disclosure may be found in the above description of FIGS. 3a to 6, which will not be repeated herein.

In an embodiment, by extracting at least one global token corresponding to the image to be processed, the model may be capable of obtaining spatial features with global attention information while maintaining a low computing amount.

The image processing method provided in an embodiment, based on spatial features comprising cross granularity attention information (global attention information and local attention information), may be capable of achieving an improved recognition rate of tiny actions, and thus an improved accuracy of a highlight recognition result.

In an embodiment, the extracted eleventh image patches comprising global attention information and local attention information may be further extracted with temporal (time) information, which may be referred to processing the third image patches.

In an embodiment, the temporal memory transformer may also be applied to directly extract temporal information for various cases of images to be processed, all of which may be achieved by using one frame of images to be processed to obtain temporal information and reduce the time of a single run. As shown in FIG. 17b, the process may include:

Step S1701: obtaining first image patches to be processed corresponding to the image to be processed.

The first image patches to be processed may be obtained by directly encoding the image to be processed, or may be image patches from which spatial information has been extracted, or may be image patches in other situations, which is not limited to the present disclosure.

Step S1702: obtaining, from a predetermined short memory pool, first processed image patches corresponding to at least one frame of a processed image prior to the image to be processed; and determining first image patches to be processed comprises temporal information, based on the first image patches to be processed and the first processed image patches.

The short memory pool may retain short memory information with fine granularity for one or more frames of the image. In an embodiment, this step 1702 may be performed by at least one short memory transformer. First processed image patches corresponding to at least one frame of processed image prior to the image to be processed, may be obtained from the predetermined short memory pool. The first processed image patches may include features representing spatial information and temporal information at a specific location in the previous one or more frames. The first processed image patches may be features with the same size as or a different size from the first image patches to be processed; and if the sizes of the first processed image patches are different from that of the first image patches to be processed, the first processed image patches and the first image patches to be processed may be transformed to features with the same size, before extracting the short temporal information.

In an embodiment, based on a consideration for both accuracy and computing amount, only the first processed image patches corresponding to one frame of processed image may be retained in the short memory pool. In practice, those skilled in the art may configure the number of frames of processed images to be retained in the short memory pool according to the actual situation, which is not limited to the present disclosure.

Further, the first processed image patches and the first image patches to be processed corresponding to the at least one frame of the obtained processed image, may be passed through one or more short memory transformers, so as to output short temporal features, i.e., the first image patches to be processed comprising temporal information, for performing step S1704.

Furthermore, the output short temporal features may be configured to update the short memory pool. That is, the short memory pool may be updated whenever the image to be processed is processed. The short memory pool may be updated, based on the first image patches to be processed comprising the temporal information. For example, when the short memory pool is updated, a new short temporal feature may be added to the short memory pool; and when the number of frames of processed images retained in the short memory pool exceeds a predetermined value, an oldest feature may be removed from the short memory pool.

Step S1703: down sampling the first image patches to be processed to obtain second image patches to be processed; and obtaining, from a predetermined long memory pool, second processed image patches respectively corresponding to at least one frame of a processed image prior to the image to be processed; and determining the second image patches to be processed comprising temporal information, based on the second image patches to be processed and the second processed image patches.

Long memory information with coarse granularity, of multiple frames of images may be retained in the long memory pool.

In an embodiment, the first image patches to be processed may be down sampled. That is, the fine granularity features may be transformed to coarse granularity features, so as to enhance the temporal features in the image to be processed by using different coarse and fine features; and thus the second image patches to be processed may be obtained. In an embodiment, the fifth image patches may be a feature down sampled to 1×1, i.e., a feature representing one video frame. In some embodiments, it may also be used as other sizes, which is not limited to the present disclosure.

In an embodiment, second processed image patches respectively corresponding to at least one frame of processed image prior to the image to be processed, may be obtained from a predetermined long memory pool. The second processed image patches comprising the temporal features of all its previous frames prior to the current frame to be processed. The second processed image patches may be features with the same size as the second image patches to be processed, such as a 1×1 feature, i.e., a feature representing one video frame. In this case, the second processed image patches may be history feature maps. In an embodiment, the second processed image patches may be features with a different size from that the second image patches to be processed. In this case, the second processed image patches and the second image patches to be processed may be transformed to features with the same size, before extracting the long temporal information.

In some applications, those skilled in the art may configure the number of frames of processed images retained by the long memory pool according to the actual situation, and embodiments of the present disclosure is not limited thereto.

In an embodiment, this step may be performed by at least one long memory transformer, i.e., by at least one long memory transformer; and the second image patches to be processed comprising the temporal information may be determined, based on the second image patches to be processed and the second processed image patches. The second processed image patches and the second image patches to be processed respectively corresponding to the at least one frame of the obtained processed image, may be passed through the at least one long memory transformer, so as to output the long temporal features, i.e., the second image patches to be processed comprising the temporal information, for performing Step S1704.

Furthermore, the output long temporal features may be configured to update the long memory pool. That is, the long memory pool may be updated whenever the image to be processed is processed. The long memory pool may be updated based on the second image patches to be processed comprising the temporal information. For example, when the long memory pool is updated, a new long temporal feature may be added to the long memory pool; and when the number of frames of the processed image retained in the long memory pool exceeds a predetermined value, an oldest feature may be removed from the long memory pool.

In some applications, those skilled in the art may configure the number of short memory transformers and the number of long memory transformers according to the actual situation. In an embodiment, the number of short memory transformers and the number of long memory transformers may be the same or different, and the present disclosure is not limited thereto.

Step S1704: determining a recognition result of the image to be processed, based on the first image patches to be processed comprising the temporal information and the second image patches to be processed comprising the temporal information.

The first image patches to be processed comprising the temporal information, and the second image patches to be processed comprising the temporal information may be fused, and the fused result may be output, and the highlight recognition result of the image to be processed may be obtained based on the fused result.

For the non-elaborated contents of an embodiment of the present disclosure may be referred to the description of FIGS. 9 to 11 above, and will not be repeated herein.

The temporal information extraction method provided in an embodiment of the present disclosure may be capable of obtaining temporal information with only one single frame when the inputs are continuous single frames of the video, reducing the time of a single run and making it possible for the model to run on edge devices. In addition, the second neural network may use long memory information with coarse granularity, and short memory information with fine granularity, to enhance the temporal features in the image to be processed to ensure that sufficient temporal information is obtained to achieve the desired recognition effect.

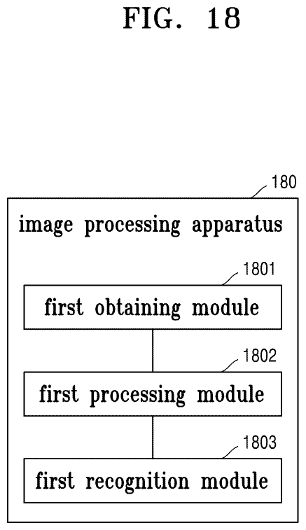

Embodiments of the present disclosure may provide an image processing apparatus. As shown in FIG. 18, the image processing apparatus 180 may comprise: a first obtaining module 1801, a first processing module 1802, and a first recognition module 1803, wherein:

The first obtaining module 1801 may be configured to obtain first image patches corresponding to the image to be processed;

The first processing module 1802 may be configured to divide the first image patches into at least two groups via a window self-attention network; and to determine the attention information among first image patches in each group of first image patches, respectively for each group of the first image patches; and to obtain second image patches comprising local attention information.

The first recognition module 1803 may be configured to determine the recognition result of the image to be processed, based on the second image patches.

In an embodiment, the first processing module 1802 may be configured to determine at least one global token corresponding to the image to be processed, based on the first image patches, by a global token generator.

The first recognition module 1803 may be configured to determine the recognition result of the image to be processed, based on the at least one global token and second image patch.

In an embodiment, the global token generator may include a kernel generator, and the first processing module 1802 may be configured to generate at least one kernel for the image to be processed by the kernel generator.

The first recognition module 1803 may be configured to determine at least one global token respectively corresponding to the at least one kernel, based on the at least one kernel and the first image patches.

The first processing module 1802 may be configured to determine the attention information among the at least one global token and second image patch via a cross granularity attention network to obtain the third image patches comprising the global attention information and the local attention information.

The first recognition module 1803 may be configured to determine the recognition result of the image to be processed based on the third image patches.

In an embodiment, at least one of the window self-attention network, the global token generator and the cross granularity attention network may be comprised in the first neural network; and the first processing module 1802 may be configured to obtain the fourth image patches comprising the global attention information and the local attention information, based on the first image patches, via the at least one first neural network.

The first recognition module 1803 may be configured to determine a recognition result of the image to be processed based on the fourth image patches.

In an embodiment, the first processing module 1802 may be further used to perform at least one down sampling for the first image patches

The first processing module 1802 may be used for each down sampling, such as down sampling output image patches of a previous first neural network, so as to get down sampled results; and functioning the down sampled results as input image patches of a next first neural network (inputting the down sampled results into a next first neural network).

In an embodiment, the first processing module 1802 is specifically configured to:
group feature points of each of the output image patches into grouped feature maps; and
concatenate the grouped feature maps in a channel dimension to obtain connected feature maps.

In an embodiment, the first recognition module 1803 may be configured to:
determine, through the second neural network, fifth image patches comprising global attention information, local attention information and temporal information, based on the third image patches; and
determine the recognition result of the image to be processed, based on the fifth image patches.

In an embodiment, the first recognition module 1803 may be configured to:
obtain, from a predetermined short memory pool, the sixth image patches respectively corresponding to at least one frame of the processed image prior to the image to be processed; and to determine the third image patches comprising the global attention information, the local attention information and the temporal information, based on the third image patches and the sixth image patches;
down sample the third image patches to obtain a seventh image patches; and to obtain, from a predetermined long memory pool, the eighth image patch corresponding to at least one frame of the processed image prior to the image to be processed, respectively; and to determine the seventh image patches comprising the temporal information, based on the seventh image patches and the eighth image patches.

Based on the third image patches comprising the global attention information, the local attention information and the temporal information and the seventh image patches comprising the temporal information, fifth image patches comprising global attention information, local attention information and temporal information may be obtained.

In an embodiment, the first recognition module 1803 may be further used for at least one of the following:
updating the short memory pool, based on the third image patches comprising the global attention information, the local attention information and the temporal information;
and

updating the long memory pool, based on the seventh image patches comprising the temporal information.

According to an embodiment, a device may perform the method provided in an embodiment with similar principles. The actions performed by the modules in the device of an embodiment correspond to the steps in the method of an embodiment, and the detailed functional description of the modules of the device and the beneficial effects produced may be specifically referred to the description in the corresponding method shown in the preceding section, which will not be repeated herein.

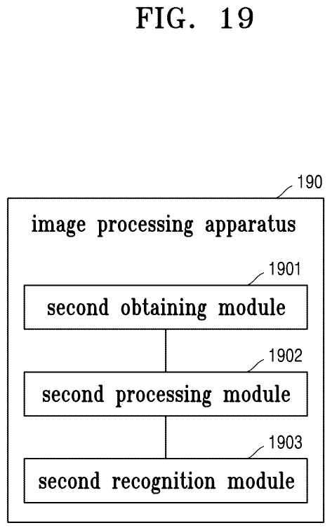

Provided is an image processing apparatus, as shown in FIG. 19, wherein the image processing apparatus 190 may comprise: a second obtaining module 1901, a second processing module 1902, and a second recognition module 1903, wherein:

The second obtaining module 1901 may be configured to obtain the first image patches corresponding to the image to be processed;

The second processing module 1902 may be configured to determine at least one global token corresponding to the image to be processed, based on the first image patches, by a global token generator

The second recognition module 1903 may be configured to determine the recognition result of the image to be processed, based on the at least one global token.

In an embodiment, the second processing module 1902 may be configured to:

generate, via a kernel generator, at least one kernel for the image to be processed; and

determine, based on the at least one kernel and the ninth image patches, at least one global token respectively corresponding to the at least one kernel.

In an embodiment, the second processing module 1902 may be configured to divide the ninth image patches into at least two groups via a window self-attention network; and, determine the attention information among the ninth image patches in each group of the ninth image patches, respectively for each group of the ninth image patches; and, to obtain the tenth image patches comprising the local attention information.

The second recognition module 1903 may be configured to determine the recognition result of the image to be processed based on the at least one global token and the tenth image patches.

The second processing module 1902 may be configured to determine the attention information among the at least one global token and the tenth image patches via a cross granularity attention network to obtain the eleventh image patches comprising the global attention information and the local attention information.

The second recognition module 1903 may be configured to determine the recognition result of the image to be processed based on the eleventh image patches.

According to an embodiment, the device may perform the method provided in an embodiment with similar embodiment principles. The actions performed by the modules in the device are corresponding to the steps in the method of an embodiment, and the detailed functional descriptions will not be repeated herein.

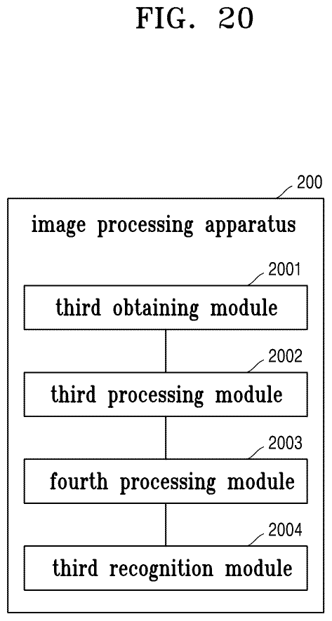

Provided is an image processing apparatus, as shown in FIG. 20, wherein the image processing apparatus 200 may comprise: a third obtaining module 2001, a third processing module 2002, a fourth processing module 2003, and a third recognition module 2004, wherein
the third obtaining module 2001 may be configured to obtain first image patches to be processed corresponding to the image to be processed;
the third processing module 2002 may be configured to obtain, from a predetermined short memory pool, first processed image patches corresponding to at least one frame of a processed image prior to the image to be processed; and to determine first image patches to be processed comprising temporal information, based on the first image patches to be processed and the first processed image patches.
a fourth processing module 2003 for down sampling the first image patches to be processed to obtain a second image patches to be processed; and obtaining, from a predetermined long memory pool, second processed image patches corresponding to at least one frame of the processed image prior to the image to be processed, respectively; and determining the second image patches to be processed comprising temporal information, based on the second image patches to be processed and the second processed image patches.

The third recognition module 2004 may be configured to determine the highlight recognition result of the image to be processed, based on the first image patches to be processed comprising the temporal information and the second image patches to be processed comprising the temporal information.

In an embodiment, the image processing apparatus 200 may comprise an update module 2005 for at least one of the following:
updating the short memory pool, based on the first image patches to be processed comprising the temporal information; and
updating the long memory pool, based on the second image patches to be processed comprising the temporal information.

According to an embodiment, a device may perform the method provided in an embodiment of the present disclosure with similar embodiment principles. The actions performed by the modules in the device are corresponding to the steps in the method of an embodiment, and the detailed functional description will not be repeated herein.

According to an embodiment, a device may be performed in at least one of a plurality of modules via an AI model. The functions associated with the AI may be performed via a non-volatile memory, a volatile memory, and a processor.

The processor may comprise one or more processors. In this case, the one or more processors may be a general purpose processor, such as a central processing unit (CPU), an application processor (AP), etc., or a pure graphics processing unit, for example, a graphics processing unit (GPU), a visual processing unit (VPU), and/or an AI-specific processor, such as a neural processing unit (NPU).

The one or more processors may control processing of the input data based on predefined operational rules or artificial intelligence (AI) models stored in non-volatile memory and/or a volatile memory. The predefined operation rules or AI models may be provided by training or learning.

Herein, providing by learning, refers to obtaining predefined operating rules or AI models with desired features by applying a learning algorithm to a plurality of learned data. The learning may be performed in the device itself in which the AI according to the embodiment is executed, and/or may be performed by a separate server/system.

The AI model may comprise a plurality of neural network layers. Each layer has a plurality of weight values, and the computing of a layer is performed by the results of the computing of the previous layer and the plurality of weights of the current layer. Examples of neural networks include, but are not limited to, convolutional neural networks (CNN), deep neural networks (DNN), recurrent neural networks (RNN), restricted Boltzmann machines (RBM), deep belief networks (DBN), bidirectional recurrent deep neural networks (BRDNN), generative adversarial networks (GAN), and deep Q networks.

A learning algorithm is a method of training a predetermined target device (e.g., a robot) using multiple learning data to enable, allow, or control the target device to make determinations or predictions. Examples of the learning algorithm include, but are not limited to, supervised learning, unsupervised learning, semi-supervised learning, or reinforcement learning.

Provided is an electronic device including a memory, a processor, and a computer program, which is stored in the memory, the processor executing the computer program to perform the steps of each of the preceding method embodiments.

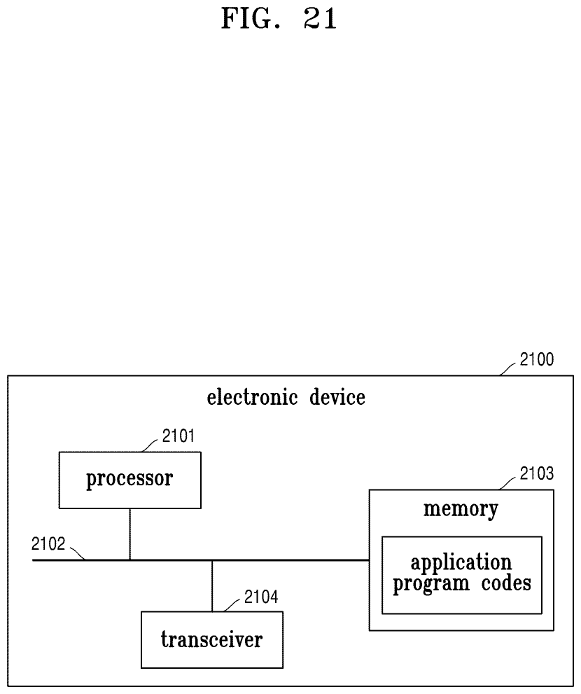

In an embodiment, provided is an electronic device as shown in FIG. 21, wherein the electronic device 2100 may include: a processor 2101 and a memory 2103. wherein the processor 2101 and the memory 2103 are connected, e.g., via a bus 2102. In an embodiment, the electronic device 2100 may also include a transceiver 2104, which may be used for data interaction between this electronic device and other electronic devices, such as the sending of data and/or the receiving of data, etc. It should be noted that the number of the transceiver 2104 is not limited to one in practical applications, and the structure of the electronic device 2100 does not constitute a limitation of embodiments of the present disclosure.

The processor 2101 may be a CPU (Central Processing Unit), a general-purpose processor, a DSP (Digital Signal Processor), an ASIC (Application Specific Integrated Circuit), or an FPGA (Field Programmable Gate Array) or other programmable logic devices, a transistorized logic device, a hardware part, or any combination thereof. It may perform or execute various exemplary logic boxes, modules, and circuits described in conjunction with the description of the present disclosure. The processor 2101 may also be a combination that performs a calculating function, such as a combination comprising one or more microprocessors, a combination of a DSP and a microprocessor, etc.

The bus 2102 may comprise a pathway to transfer information among the above components. The bus 2102 may be a PCI (Peripheral Component Interconnect) bus or an EISA (Extended Industry Standard Architecture) bus, etc. The bus 2102 may be divided into address bus, data bus, control bus, etc. For the convenience of representation, only one thick line is used in FIG. 21, but it does not mean that there is only one bus or one type of bus.

Memory 2103 may be a ROM (Read Only Memory) or other type of static storage device that may store static information and instructions, a RAM (Random Access Memory) or other type of dynamic storage device that may store information and instructions, or an EEPROM (EEPROM (Electrically Erasable Programmable Read Only Memory), CD-ROM (Compact Disc Read Only Memory) or other optical disc storage, optical disc storage (including compressed disc, laser disc, optical disc, digital universal optical disc, Blu-ray disc, etc.), disk storage medium, other magnetic storage devices, or any other media capable of being configured to carry or store a computer program and capable of being read by a computer, which is not limited to the embodiment of the present disclosure herein.

The memory 2103 may be configured to store a computer program for executing an embodiment and may be controlled for execution by the processor 2101. The processor 2101 may be configured to execute the computer program stored in the memory 2103 to perform the steps described herein.

The electronic devices may include, but are not limited to, terminal devices such as fixed terminals and/or mobile terminals, such as: cell phones, tablet computers, laptops, wearable devices, game consoles, desktops, all-in-one computers, vehicle terminals, robots, and the like. The electronic device may include an image processing module for image processing. In an embodiment, the electronic device may be a server for processing the uploaded images.

In an embodiment, the method for extracting cross granularity attention information and temporal information in the image processing method performed in the electronic device may obtain output data for recognizing an image or a highlighted portion of an image by using image data as input data for an artificial intelligence model. The artificial intelligence model may be obtained by training. Here, “obtained by training” means that the basic artificial intelligence model is trained with multiple training data by a training algorithm to obtain predefined operational rules or artificial intelligence models configured to perform the desired feature (or purpose). The artificial intelligence model may comprise multiple neural network layers. Each layer of the plurality of neural network layers comprises a plurality of weight values and performs neural network computations by calculating between the results of the previous layer and the plurality of weight values.

Visual understanding is a technique for recognizing and processing things like human vision and comprises, for example, object recognition, object tracking, image retrieval, human recognition, scene recognition, 3D reconstruction/localization, or image enhancement.

Embodiments of the present disclosure provide a computer readable storage medium having a computer program stored on the computer readable storage medium, the computer program when executed by a processor may perform the steps and corresponding contents of the foregoing method embodiments.

Embodiments of the present disclosure also provide a computer program product comprising a computer program, the computer program when executed by a processor realizing the steps and corresponding contents of the preceding method embodiments.

The terms “first”, “second”, “third”, “fourth”, “third” and “fourth” in the specification and claims of the present disclosure and in the accompanying drawings above “, “1”, “2”, etc. are configured to distinguish similar objects and need not be configured to describe a particular order or sequence. Furthermore, the terms “temporal” preceding a reference to one of the image patches is used solely to distinguish similar image patches, and should not be construed to limit the term in any other manner. It should be understood that the data so used is interchangeable where appropriate so that embodiments of the present disclosure described herein may be performed in an order other than that illustrated or described in the text.

It should be understood that while the flowcharts of embodiments of the present disclosure indicate the operational steps by arrows, the order in which these steps are performed is not limited to the order indicated by the arrows. Unless explicitly stated herein, in some embodiments, the implementation steps in the flowcharts may be performed in other orders as desired. In addition, some or all of the steps in the flowcharts may comprise multiple sub-steps or multiple stages based on actual embodiment situations. Some or all of these sub-steps or phases may be executed at the same moment, and each of these sub-steps or phases may also be executed respectively at different moments. In the situation where the execution time is different, the execution order of these sub-steps or stages may be flexibly configured according to the demand, and the present disclosure is not limited thereto.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An image processing method comprising:
obtaining first image patches corresponding to an image to be processed;
dividing the first image patches into at least two groups via a window self-attention network;
determining global attention information among the first image patches in the at least two groups of the first image patches, respectively;
obtaining second image patches comprising local attention information; and
determining a recognition result of the image to be processed based on the second image patches.

2. The image processing method of claim 1, wherein the determining the recognition result of the image to be processed based on the second image patches comprises:
determining, by a global token generator, at least one global token corresponding to at least part of the image to be processed, based on the first image patches; and
determining the recognition result of the image to be processed, based on the at least one global token and the second image patches.

3. The image processing method of claim 2, wherein the global token generator comprises a kernel generator, and
wherein the determining, by the global token generator, the at least one global token corresponding to the at least part of the image to be processed based on the first image patches, comprises:
generating at least one kernel for the image to be processed, by the kernel generator; and
determining the at least one global token respectively corresponding to the at least one kernel, based on the at least one kernel and the first image patches.

4. The image processing method of claim 2, wherein the determining the recognition result of the image to be processed based on the at least one global token and the second image patches, comprises:
determining, via a cross-attention network, attention information among the at least one global token and the second image patches;
obtaining third image patches comprising the global attention information and the local attention information; and
determining the recognition result of the image to be processed based on the third image patches.

5. The image processing method of claim 4, wherein at least one of the window self-attention network, the global token generator and the cross-attention network comprises a first neural network,
wherein the determining the recognition result of the image to be processed based on the first image patches comprises:
obtaining fourth image patches comprising the global attention information and the local attention information based on the first image patches, via at least one first neural network; and
determining the recognition result of the image to be processed, based on the fourth image patches,
wherein, the obtaining the fourth image patches comprising the global attention information and the local attention information based on the first image patches, via the at least one first neural network, further comprises:
performing at least one down sampling for the first image patches, and
wherein the at least one down sampling respectively comprises:
down sampling output image patches of a previous first neural network to obtain down sampled results; and
inputting the down sampled results into a first neural network next to the previous first neural network.

6. The image processing method of claim 5, wherein, for each of the output image patches of the previous first neural network, the down sampling the output image patches comprises:
grouping feature points of each of the output image patches into grouped feature maps; and
concatenating the grouped feature maps in a channel dimension to obtain connected feature maps.

7. The image processing method of claim 4, wherein the determining the recognition result of the image to be processed based on the third image patches comprises:
determining fifth image patches comprising the global attention information, the local attention information and temporal information based on the third image patches, via a second neural network; and
determining the recognition result of the image to be processed, based on the fifth image patches.

8. The image processing method of claim 7, wherein the determining the fifth image patches comprising the global attention information, the local attention information and the temporal information based on the third image patches, via the second neural network, comprises:
obtaining, from a predetermined short memory pool, sixth image patches corresponding to at least one frame of a processed image prior to the image to be processed;
determining temporal third image patches comprising the global attention information, the local attention information and the temporal information, based on the third image patches and the sixth image patches;
down sampling the third image patches to obtain seventh image patches;
obtaining, from a predetermined long memory pool, eighth image patches corresponding to the at least one frame of the processed image prior to the image to be processed;
determining temporal seventh image patches comprising temporal information, based on the seventh image patches and the eighth image patches; and
obtaining the fifth image patches comprising the global attention information, the local attention information and the temporal information, based on the temporal third image patches and the temporal seventh image patches.

9. The image processing method of claim 8, wherein the method further comprises at least one of:
updating the short memory pool, based on the temporal third image patches; and
updating the long memory pool, based on the temporal seventh image patches.

10. The image processing method of claim 1, wherein the image to be processed comprises a plurality of frames,
wherein the determining the recognition result of the image to be processed comprises determining a recognition result of the plurality of frames, respectively, and
wherein the method further comprises:
based on the determined recognition result of the plurality of frames, recognizing one or more highlight among the plurality of frames.

11. The image processing method of claim 10, wherein the recognizing the one or more highlights among the plurality of frames comprises:
dividing the image to be processed into a plurality of snippets of a fixed length;
determining a highlight recognition score for the plurality of snippets, respectively; and
classifying the plurality of snippets into highlight portions or non-highlight portions based on the highlight recognition score.

12. The image processing method of claim 11, wherein the recognizing the one or more highlights among the plurality of frames further comprises:
integrating adjacent snippets classified as a highlight portion, based on the adjacent snippets corresponding to a same type of highlight; and
determining a start time and an end time of the integrated adjacent snippets as the one or more highlights.

13. The image processing method of claim 3, wherein the at least one global token corresponds to one or more features to be extracted in the image to be processed, and
wherein the generating the at least one kernel for the image to be processed, by the kernel generator, comprises:
adapting a size of the at least one kernel to correspond to the one or more features to be extracted.

14. The image processing method of claim 1, wherein a resolution of the second image patches is lower than a resolution of the first image patches.

15. An image processing apparatus, comprising:
at least one processor; and
at least one memory storing instructions executable by the at least one processor,
wherein, by executing the instructions, the at least one processor is configured to control:
a first obtaining module to obtain first image patches corresponding to an image to be processed;
a first processing module to:
divide the first image patches into at least two groups via a window self-attention network,
determine global attention information among first image patches in the at least two groups of the first image patches, respectively, and
obtain second image patches comprising local attention information; and
a first recognition module to determine a recognition result of the image to be processed, based on the second image patches.

16. The image processing apparatus of claim 15, wherein the at least one processor is further configured to control:
the first processing module to:
determine, by a global token generator, at least one global token corresponding to at least part of the image to be processed, based on the first image patches; and
the first recognition module to:
determine the recognition result of the image to be processed, based on the at least one global token and the second image patches.

17. The image processing apparatus of claim 16, wherein the global token generator comprises a kernel generator,
wherein the at least one processor is further configured to control:
the first processing module to:
generate at least one kernel for the image to be processed, by the kernel generator; and
the first recognition module to:
determine the at least one global token respectively corresponding to the at least one kernel, based on the at least one kernel and the first image patches.

18. The image processing apparatus of claim 16, wherein the at least one processor is further configured to control:
the first processing module to:
determine, via a cross-attention network, attention information among the at least one global token and the second image patches, and
obtain third image patches comprising the global attention information and the local attention information; and
the first recognition module to:
determine the recognition result of the image to be processed based on the third image patches.

19. The image processing apparatus of claim 18, wherein at least one of the window self-attention network, the global token generator and the cross-attention network comprises a first neural network,
wherein the at least one processor is further configured to:
for determining the recognition result of the image to be processed based on the first image patches, control the first processing module to:
obtain fourth image patches comprising the global attention information and local attention information based on the first image patches, via at least one first neural network;
for determining the recognition result of the image to be processed based on the first image patches, control the first recognition module to:
determine the recognition result of the image to be processed, based on the fourth image patches;
for obtaining the fourth image patches comprising the global attention information and the local attention information based on the first image patches via the at least one first neural network, control the first processing module to:
perform at least one down sampling for the first image patches; and
for performing the at least one down sampling, control the first processing module to:
down sample output image patches of a previous first neural network to obtain down sampled results, and
input the down sampled results into a first neural network next to the previous first neural network.

20. A non-transitory computer readable storage medium having a computer program stored therein, wherein when the computer program is executed by at least one processor, the computer program performs the image processing method according to claim 1.
